(19) United States
(12) Patent Application Publication
(10) Pub. No.: US 2008/0044038 A1
(43) Pub. Date: Feb. 21, 2008

(54) Stereophonic sound system

(76) Inventor: Douglas W. Houle, Clinton Township, MI (US)

Correspondence Address: Gerald R. Black, Esq., Suite 67A, 30320 Southfield Road, Southfield, MI, 48076, US

(21) Appl. No.: 11/648,741

(22) Filed: Jan. 3, 2007

Related U.S. Application Data
(60) Provisional application No. 60/853,550, filed on Oct. 23, 2006.
(60) Provisional application No. 60/838,296, filed on Aug. 18, 2006.

(51) Int. Cl. H04R 1/40

(52) U.S. Cl. 381/97

(57) ABSTRACT

The stereophonic sound system attenuates the audio power level delivered to the auxiliary speakers relative to the audio power level delivered to the main speakers so that the radiated sound pressure level from the auxiliary speakers is less than the radiated sound pressure level from the main speakers; blocks the tow frequency audio power from being delivered to the auxiliary speakers; and shapes the radiated dispersion pattern by controlling the phase relationship between the auxiliary speakers and the main speakers. This system widens the stereophonic sweet spot, eliminates soundstage shift, corrects off-axis response, and improves off-axis phantom image specificity, thus improving stereophonic realism over and above the present art. Stereophonic “realism” is a subjective assessment of the degree to which the sound from an audio system approaches that of live music.

This application is related to and claims priority to U.S. Provisional Application No. 60/853,550 entitled “Stereophonic Sound System”, filed 23 Oct. 2006, by Douglas W. Houle; and U.S. Provisional Application No. 60/838,296, entitled “A Process For Creating A Uniform Independent Stereophonic Sound Field For A Plurality Of Listeners”, filed on Aug. 18, 2006, by Douglas W. Houle.

### FIELD OF USE

The present invention is a stereophonic sound system, and more particularly, a stereophonic sound system comprising a pair of main speakers and a pair of auxiliary speakers that widens the stereophonic sweet spot, eliminates soundstage shift, corrects off-axis response, and improves off-axis phantom image specificity.

### BACKGROUND OF THE INVENTION

Standard stereo reproduction has many limitations. The followings patents depict stereophonic speaker systems using main and auxiliary speakers.
U.S. Pat. No. 4,723,289 (Schreiber, et al.) entitled “Stereo Electroacoustic Transducing,” describes a stereo loudspeaker system that includes left and right loudspeaker cabinets each having a woofer mounted off center on the front baffle and tweeters mounted in front of the woofer with the axis of each tweeter at an angle to that of the woofer. Left and right loudspeakers have symmetrical, mirror-image, cross-fired, acoustic radiation patterns.
U.S. Pat. No. 4,764,960 (Aoki, et al.) entitled “Stereo Reproduction System” describes left and right channel loudspeakers having respective main axes of directivities directed toward left and right listening areas defined in front thereof. In addition, there are provided a second right channel loudspeaker near the first right channel loudspeaker with a main axis of directivity directed toward the left listening area, a second left channel loudspeaker near the first left channel loudspeaker with a main axis of directivity directed toward the right listening area, and signal adjusting means for controlling the relative amplitude and time difference among the signals to be supplied to these loudspeakers.
U.S. Pat. No. 4,860,363 (Suzuki, et al.) entitled “Loudspeaker System” describes a system in which sound radiation axes of two speakers in a single loudspeaker unit form an angle with respect to each other in a horizontal plane to increase the size of a listening area. The horizontal angle can be formed by orienting the sound axes of speakers in the loudspeaker unit at an angle in the range of 15 to 45 degrees from each other.
U.S. Pat. No. 4,932,060 (Schreiber) entitled “Stereo Electroacoustical Transducing” depicts a woofer enclosure having left and right input terminal pairs and left and right output terminal pairs. A protection circuit, woofer, satellite protection capacitor, satellite passive equalizer and light bulb intercouple the woofer enclosure input terminal pair and output terminal pair. Left and right satellite assemblies each include a lower enclosure and an upper enclosure with each enclosure including a single full-range driver. Each lower enclosure includes an input terminal pair connected to a respective output terminal pair of the woofer enclosure.
U.S. Pat. No. 5,181,247 (Holl) entitled “Sound Image Enhancing” depicts a speaker system with a left and a right channel input for receiving left and right channel signals respectively, a left channel driver, a right channel driver, an (L-R) driver unit, and a (R-L) driver unit. The left channel driver is coupled to the left channel input, and the right channel driver is coupled to the right channel input. The (L-R) driver unit and the (R-L) driver unit have structure arranged to passively differentially combine the signals on the inputs to provide (L-R) and (R-L) acoustic output signals respectively.

What is needed is a stereophonic sound system that widens the stereophonic sweet spot, eliminates soundstage shift, corrects off-axis response, and improves off-axis phantom image specificity, thus improving stereophonic realism over and above the present art.

What is need is a stereophonic sound reproduction system that generally overcomes the deficiencies of the prior art; that provides a sound reproduction system that provides an enhanced stereophonic image within a large listening area; that improves stereophonic realism, which is a subjective assessment of the degree to which the sound from an audio system approaches the sound system of live music.

### SUMMARY OF THE INVENTION

The stereophonic sound system of the present invention addresses these needs.

The stereo loudspeaker system of the present invention comprises a pair of main speakers, each main speaker being spaced apart from the other, and a pair of auxiliary speakers positioned relative to the main speakers.

The stereophonic sound system of the present invention also preferably includes means for blocking low frequency audio power from being delivered to the auxiliary speakers. The low frequency audio power is preferably in the range of from about 100 Hz to about 3,000 Hz.

The stereophonic sound system of the present invention also includes preferably includes means for using a phase shift circuit to vary the phase relationship between the main speakers and the auxiliary speakers. The phase shift circuit controls the phase angle relationship between audio power delivered to the main speakers and audio power delivered to the auxiliary speakers.

The stereophonic sound system of the present invention also preferably includes means for attenuating audio power level delivered to the first and the second auxiliary speakers. The first auxiliary audio power level delivered to the first auxiliary speaker is attenuated relative to the first main audio power level delivered to the first main speaker so that radiated sound pressure level from the first auxiliary speakers is equal to or less than the radiated sound pressure level from the first main speaker. The second auxiliary audio power level delivered to the second auxiliary speaker is attenuated relative to the second main audio power level delivered to the second main speaker so that radiated sound pressure level from the second auxiliary speakers is equal to or less than the radiated sound pressure level from the second main speaker.

The acoustic power emanating from the first main speaker and the first auxiliary speaker blend together to form a wider dispersion angle than the acoustic power emanating from the first main speaker. Also, the acoustic power emanating from the second main speaker and the second auxiliary speaker blend together to form a wider dispersion angle than the acoustic power emanating from the second main speaker.

Below is a list of some terms used in this specification.
A “standard stereo,” as shown in FIG. 2A, is designed and optimized for a single listener located equidistant from the left and right loudspeakers, referred to herein as the sweet spot. Moving to the side, away from the sweet pot, causes the stereo image, or the soundstage, to collapse towards the nearer loudspeaker.
The “sweet spot” is that listening seat from which the best soundstage presentation is heard. Usually the sweet spot is located only in the center seat equidistant from the loudspeakers (see FIG. 2A). The sweet spot is generally narrow, only being large enough for one person. The sweet spot is the prime listening position for a stereo audio system; the “best seat in the house.” The sweet spot is the listening position for which an audio system is optimized. Normally located halfway between the speakers and back six to eight feet for a stereo audio system, the sweet spot is where the sound quality is optimal. The listener positioned at the sweet spot experiences a spacious broad panoramic stereo image. The stereo image is equally spread throughout the space between the left and right speakers; and is equally spread throughout the soundstage.
“Soundstage” is the accuracy with which a reproducing system conveys audible information about the size, shape, and acoustical characteristics of the original recording space and the placement of the performers within the recording space. The ideal stereo soundstage for a large performing group will center the performers across an area of about two-thirds or three-quarters of the distance between the loudspeakers, and will audibly separate the front rows from the receding rows, sometimes referred to as layering. There is an awareness of the reflective boundary walls of the acoustic space behind and to the sides of the performers, and the spatiality of the hall extends a considerable distance beyond the distance between the loudspeakers.
“Soundstage shift” is the apparent lateral movement or collapse of the soundstage when listening from either side of the sweet spot. The listener to the left of the sweet spot perceives a left soundstage shift and the listener to the right of the sweet spot perceives a right soundstage shift.
“Phantom image” is the re-creation by a stereo system of an apparent sound source at a location other than that of either loudspeaker. A phantom image is a focused, precise point in the soundstage where a sound source appears to be located. A phantom image is an exact location where the sound source is perceived as occupying, and appears to have a physical size that is quite narrow, and precisely located in the soundstage.
“Phantom image specificity” refers to the degree to which a phantom image exhibits a definite and unambiguous lateral position, without wander or excessive width.
“Off-axis phantom image specificity” is the off-axis phantom image specificity of most loudspeaker systems show reduced or collapsed phantom image specificity as the listener moves off-axis away from the sweet spot.
“Phantom center image” is perceived, in stereo or surround-sound systems, when the same sound is radiated from left and right loudspeakers, and the listener is exactly equidistant from both loudspeakers.
“On-axis response” refers to the frequency response for a listener positioned directly on axis with a loudspeaker and directly in front of the speaker. The on-axis listener hears the full high frequency response reproduced by the loudspeaker. An important part of the overall response of the loudspeaker is how the characteristics of the speaker changes as the listener moves off axis.
“Off-axis response” is the frequency response measured for a listener positioned at the side of a loudspeaker. This is in contrast with on-axis response, which is the frequency response measured for a listener positioned directly in front of the baffle. Typically, the off-axis response of most loudspeakers shows reduced high-frequency response as the listener moves off-axis around the loudspeaker. Related to loudspeaker dispersion, off-axis response refers to the sonic window on either side of a direct axis of a loudspeaker relative to the listener.

For the purposes of illustrating the invention, the terms left and right when used to spatially define an object herein are made with reference to the left hand and right hand side of a listener.

For a more complete understanding of the stereophonic sound system of the present invention, reference is made to the following detailed description and accompanying drawings in which the presently preferred embodiments of the invention are shown by way of example. As the invention may be embodied in many forms without departing from spirit of essential characteristics thereof, it is expressly understood that the drawings are for purposes of illustration and description only, and are not intended as a definition of the limits of the invention. Throughout the description, like reference numbers refer to the same component throughout the several views.

### BRIEF DESCRIPTION OF THE DRAWINGS

FIG. 1A discloses the preferred embodiment of the post-amplification stereophonic sound system of the present invention.

FIGS. 1B, 1C, 1D, and 1E depict alternate embodiments of post-amplification sound systems of the present invention.

FIGS. 2A, 2B, and 2C depict drawbacks in the prior art of various stereophonic sound systems.

FIGS. 3A through 3H depict various wiring block diagrams for the preferred embodiments of the stereophonic sound systems of the present invention.

FIGS. 4A, 4B, and 4C depict dispersion patterns from the main and auxiliary speakers for the preferred embodiments of the stereophonic sound system of the present invention.

FIG. 5A depicts a simplified block diagram for a pre-amplification adaptor for the stereophonic sound system of the present invention.

FIG. 5B depicts a simplified block diagram for a post-amplification adaptor for the stereophonic sound system of the present invention.

FIGS. 6A, 6B, 6C, and 6D disclose off-axis response correction factors for the stereophonic sound system of the present invention.

FIGS. 7A and 7B disclose simplified depictions of the technology used by the auxiliary speaker extending the main speaker lobe for the stereophonic sound system of the present invention.

FIG. 8 discloses a simplified block diagram for an after-market two-way system for the stereophonic sound system of the present invention.

FIG. 9 discloses a simplified block diagram for an integrated two-way system for the stereophonic sound system of the present invention.

FIG. 10 discloses a simplified block diagram for an after-market three-way system for the stereophonic sound system of the present invention.

FIG. 11 discloses a simplified block diagram for an integrated three-way system for the stereophonic sound system of the present invention.

FIGS. 12A through 12E depict various preferred embodiments of first-order, second-order, third-order, and fourth-order high-pass filters for the stereophonic sound system of the present invention.

FIGS. 13A through 13E depict various preferred embodiments of first-order, second-order, third-order, and fourth-order phase shift networks for the stereophonic sound system of the present invention.

FIGS. 14A through 14F depict various preferred embodiments of other phase shift networks embodiment schematics for the stereophonic sound system of the present invention.

FIG. 15 discloses yet another phase shift network for the stereophonic sound system of the present invention, the phase shift network being a balanced 4th order bridge.

FIGS. 16A and 16B disclose two different shunt capacitor phase shift networks that are compatible with the stereophonic sound system of the present invention that are known in the prior art.

FIGS. 17A, 17B and 17C depict various preferred embodiments of factory preset static passive attenuators for the stereophonic sound system of the present invention.

FIGS. 18A through 18F depict various preferred embodiments for continuously variable passive attenuators for the stereophonic sound system of the present invention.

FIGS. 19A through 19D depict various preferred embodiments for factory preset tapped-inductor impedance matching circuits for the stereophonic sound system of the present invention.

FIGS. 20A through 20H depict various preferred embodiments for continuously variable attenuator tapped-inductor impedance matching circuits for the stereophonic sound system of the present invention.

FIGS. 21A through 21D depict various preferred embodiments for factory preset transformer impedance matching circuits for the stereophonic sound system of the present invention.

FIGS. 22A through 22H depict various preferred embodiments for continuously variable attenuator transformer impedance matching circuits for the stereophonic sound system of the present invention.

FIGS. 23A through 23D depict various preferred embodiments for factory preset static attenuator tap-switched transformer impedance matching circuits for the stereophonic sound system of the present invention.

FIGS. 24A through 24H depict various preferred embodiments for continuously variable attenuator tap-switched transformer impedance matching circuits for the stereophonic sound system of the present invention.

### DETAILED DESCRIPTION OF THE PREFERRED EMBODIMENTS OF THE INVENTION

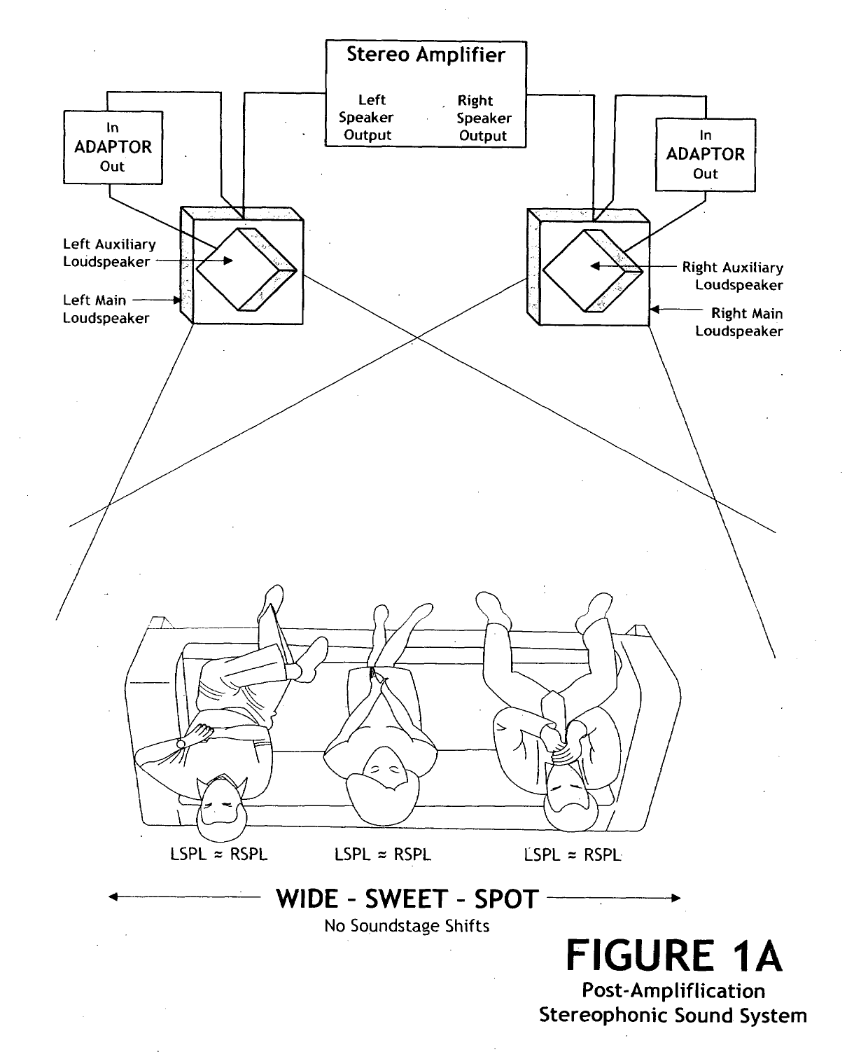

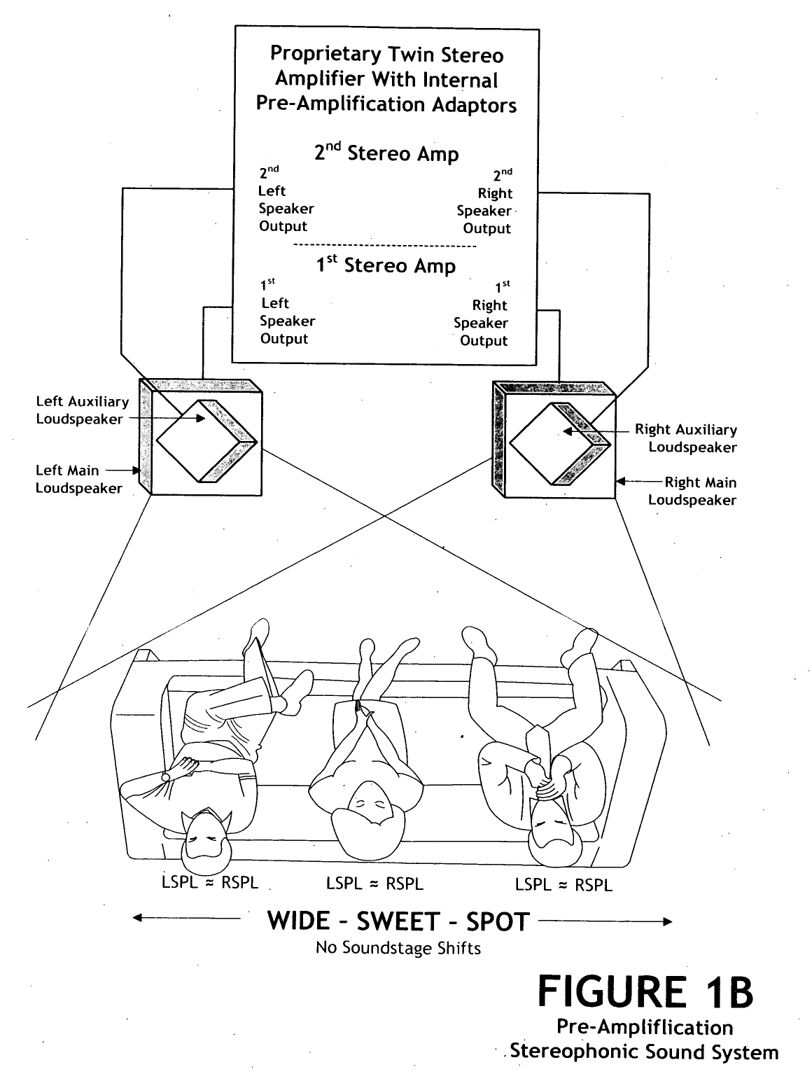

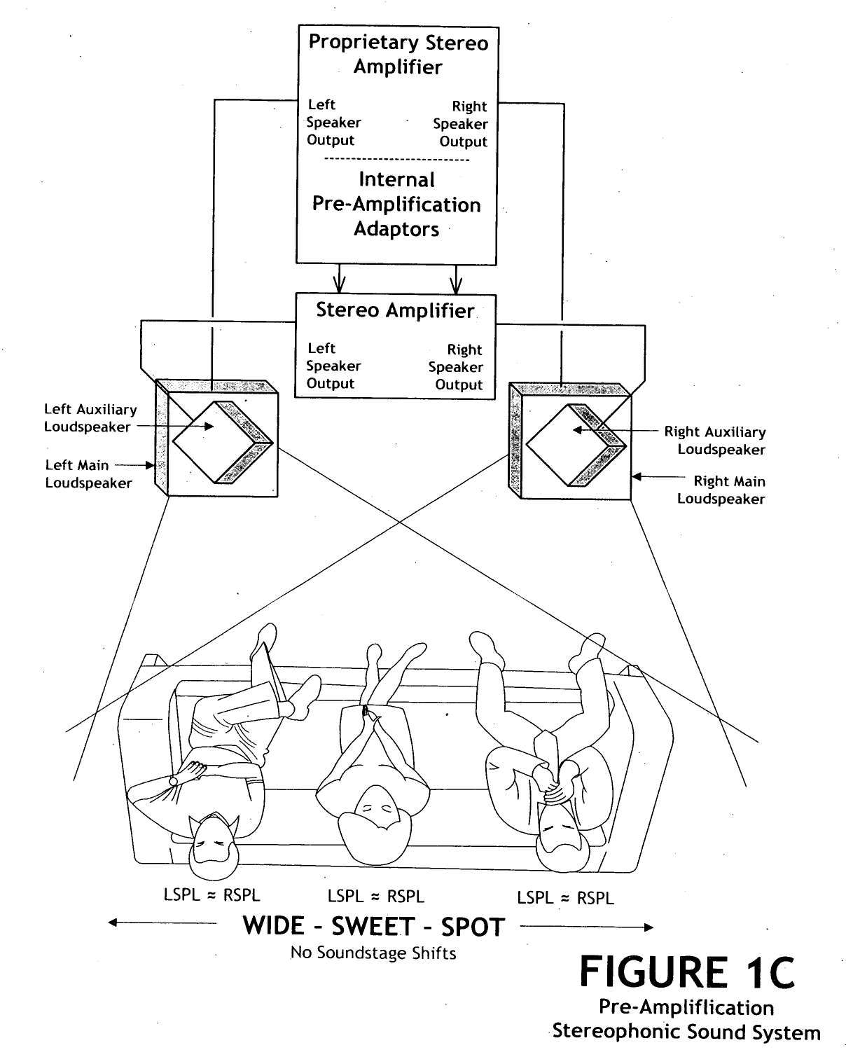

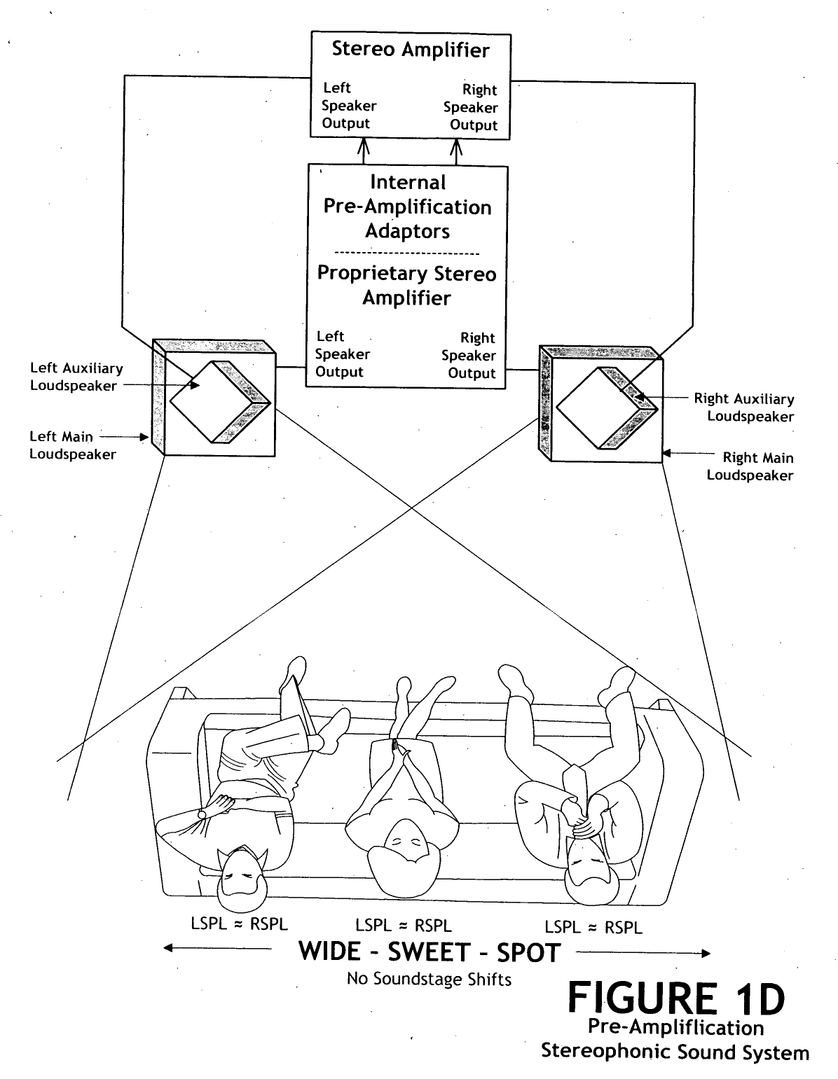

FIG. 1A discloses a stereophonic amplifier using the preferred embodiment of the pre-amplification stereophonic sound system of the present invention, the stereophonic sound signal from the amplifier being fed to a pair of main loudspeakers, and then through a pair of adaptors into a pair of auxiliary speakers, each auxiliary speaker being positioned relative to one of the main loudspeakers. FIGS. 1B, 1C, 1D, and 1E disclose alternate embodiments for post-amplification stereophonic sound systems of the present invention.

For purposes of illustration only, the preferred embodiment of the stereophonic sound system of this invention as depicted in FIG. 1A is being used hereafter for reference purposes. However, it is understood that one having skill in the art can readily apply the teachings of this specification to the alternate preferred embodiments shown in FIGS. 1B, 1C, 1D and 1E.

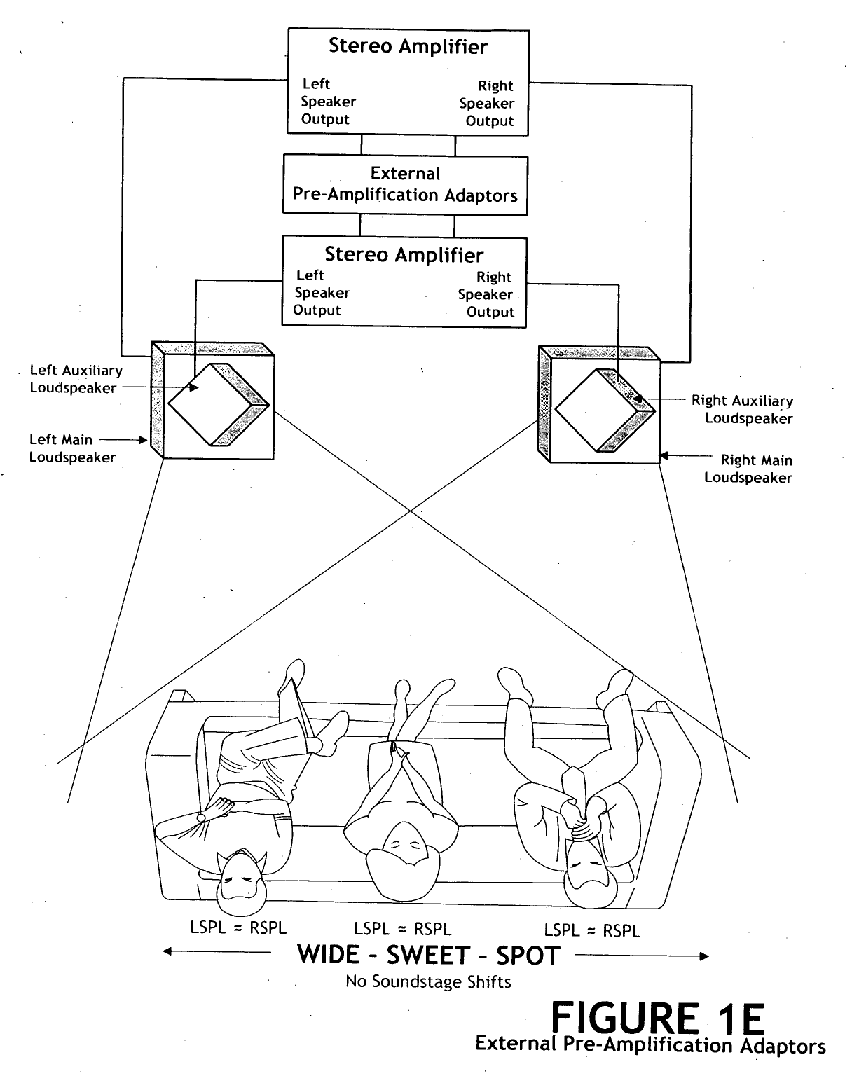

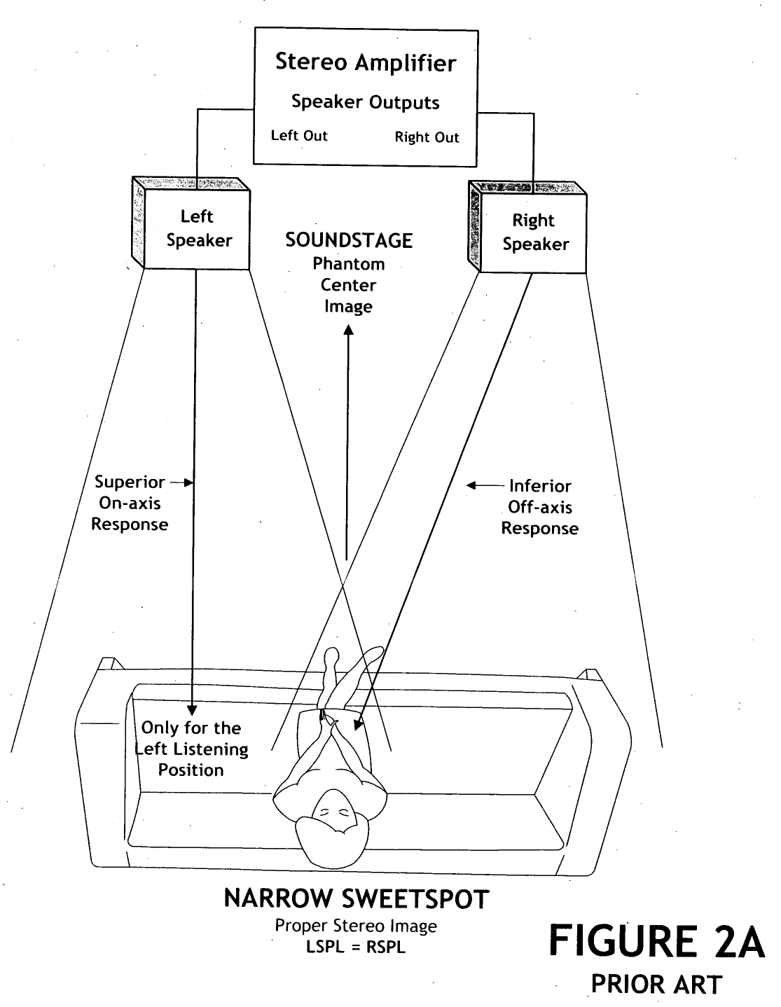

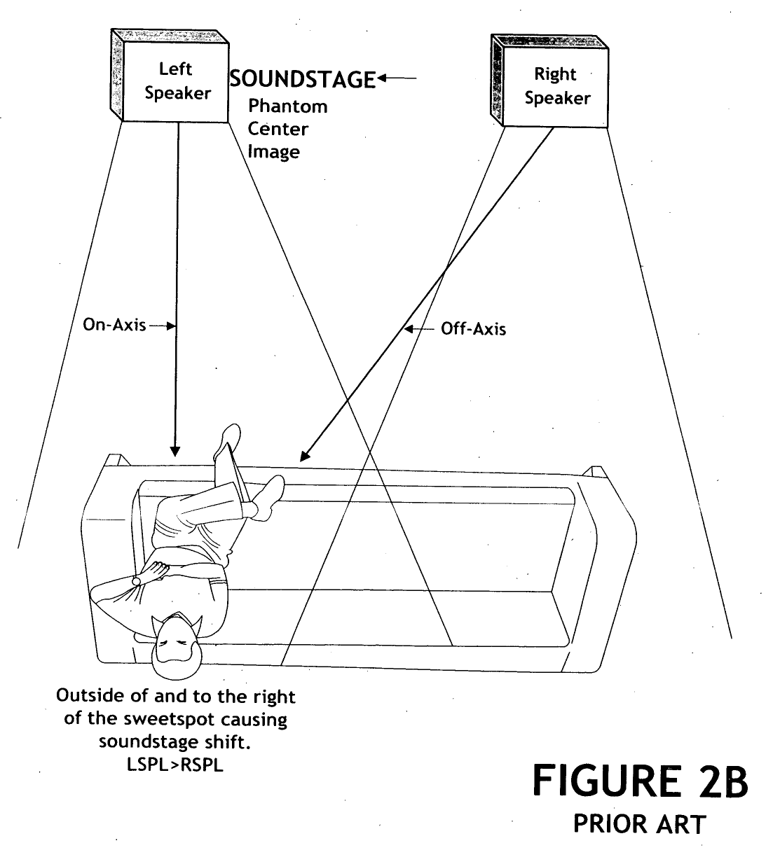

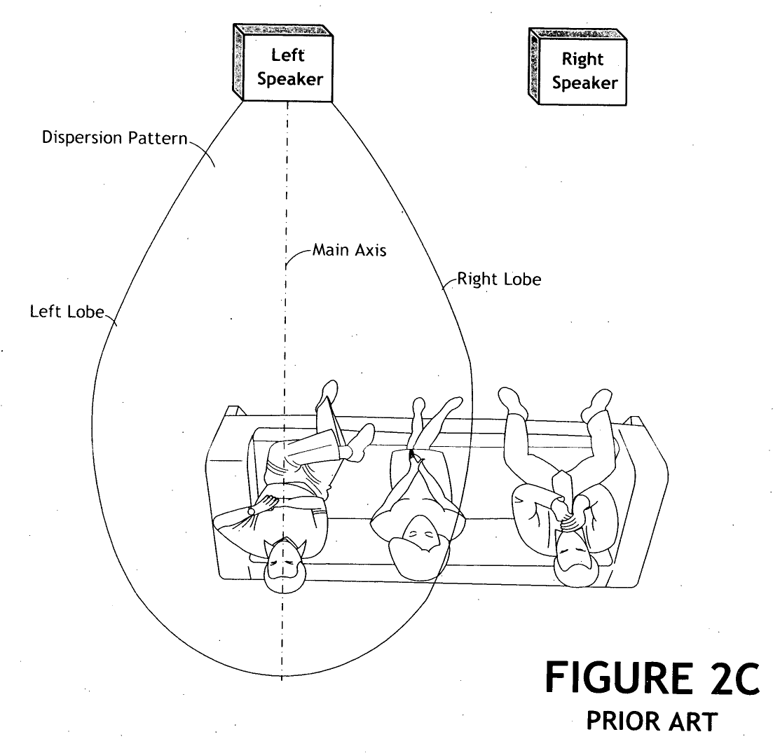

FIG. 2A depicts a typical stereo set up known in the prior art. The stereo is designed and optimized for a single listener located in the center position. It has a narrow sweet spot and the listener experiences inferior off-axis response from both the left and right speakers. The sweet spot exists where the on-axis response does not exist and the on-axis response exists where the sweet spot does not exist. Unfortunately, they both do not exist at the same site.

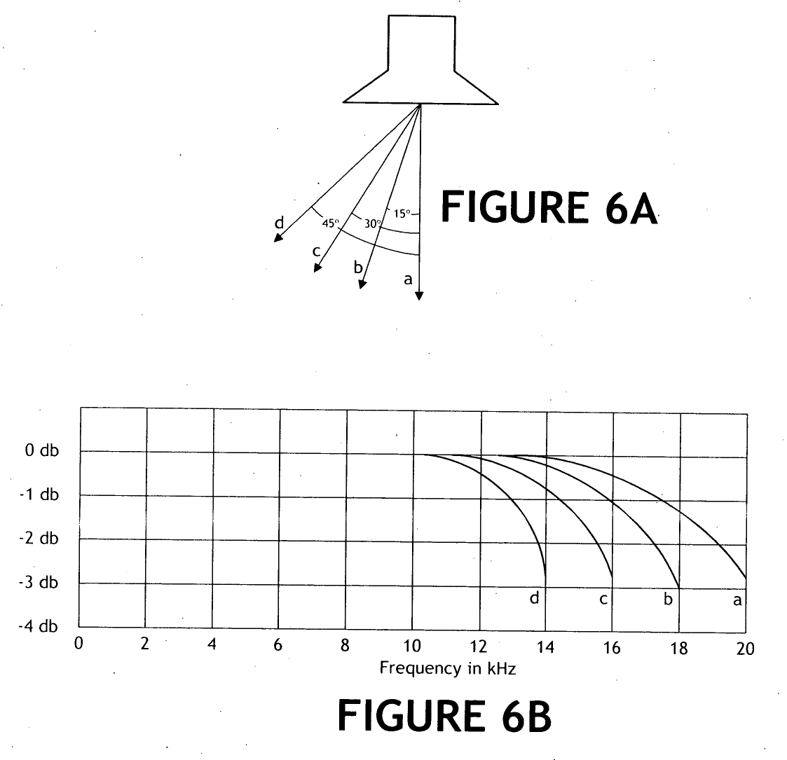

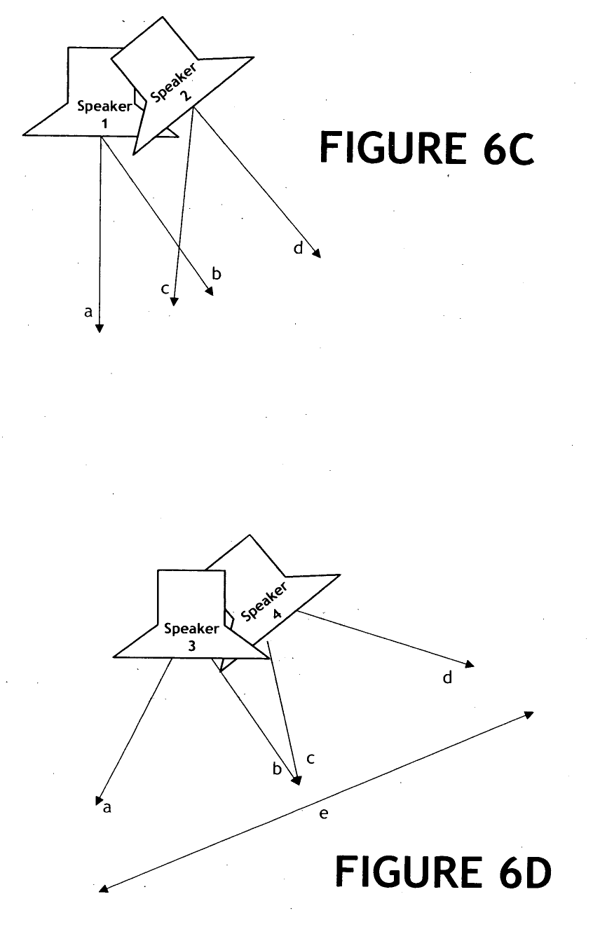

FIG. 2B depicts the listener positioned opposite the left speaker, and off-axis from the right speaker as known in the prior art. The listener experiences left soundstage shift. The soundstage and the phantom images, the off-axis phantom image specificity, such as the phantom center image are shifted to the left and the phantom image specificity is squeezed or collapsed to the left. The listener also experiences severe off-axis response from the right speaker, as shown in FIGS. 6A and 6B.

FIG. 2C depicts the left main speaker dispersion pattern as known in the prior art. The dispersion pattern is symmetrical with respect to the main axis of the left main speaker. The pattern on the left side of the axis is a mirror image of the pattern to the right of the axis. The listener seated in the right position is not included in the dispersion pattern for the left main speaker. Also, the listener seated in the left position is outside the dispersion pattern for the right main speaker.

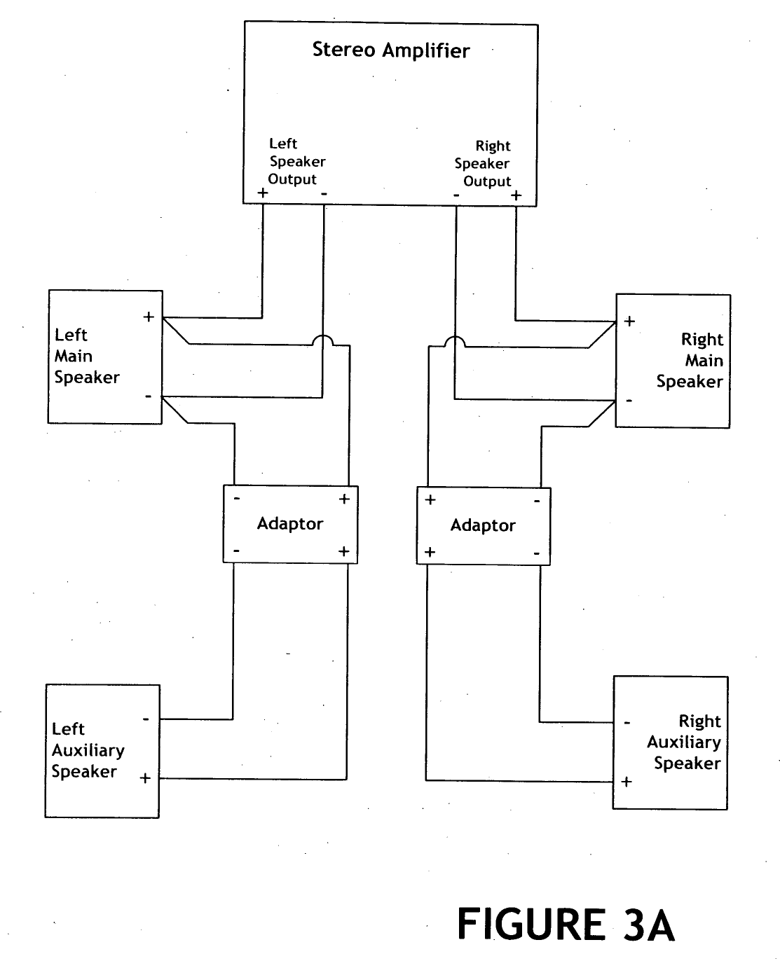

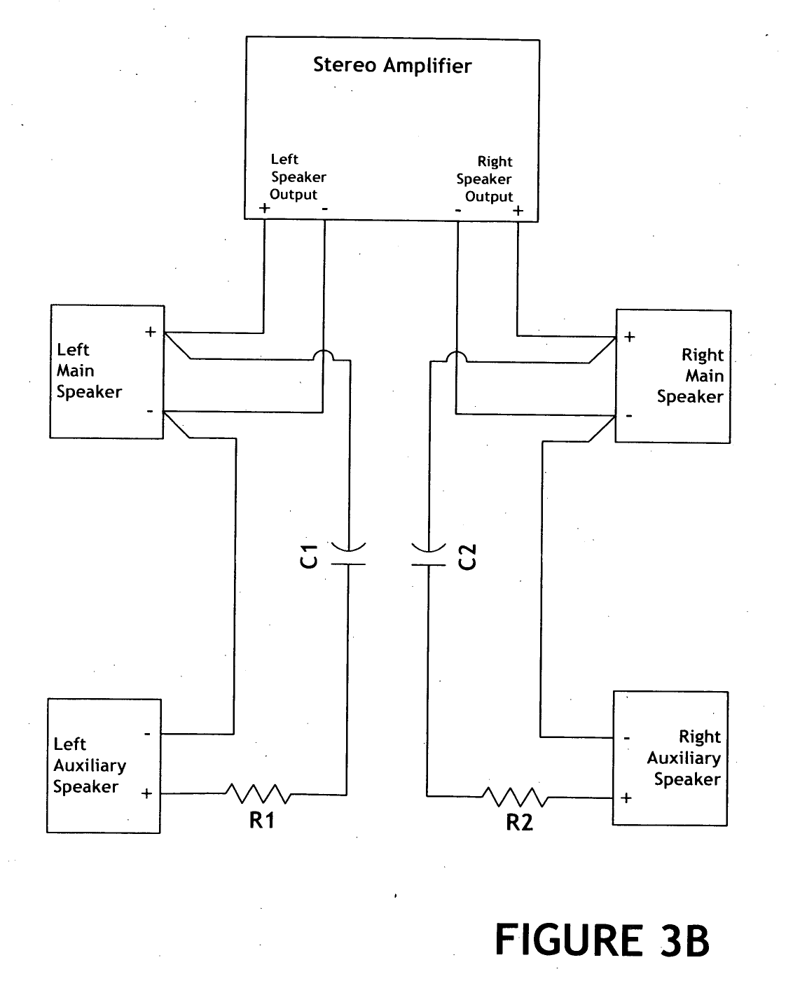

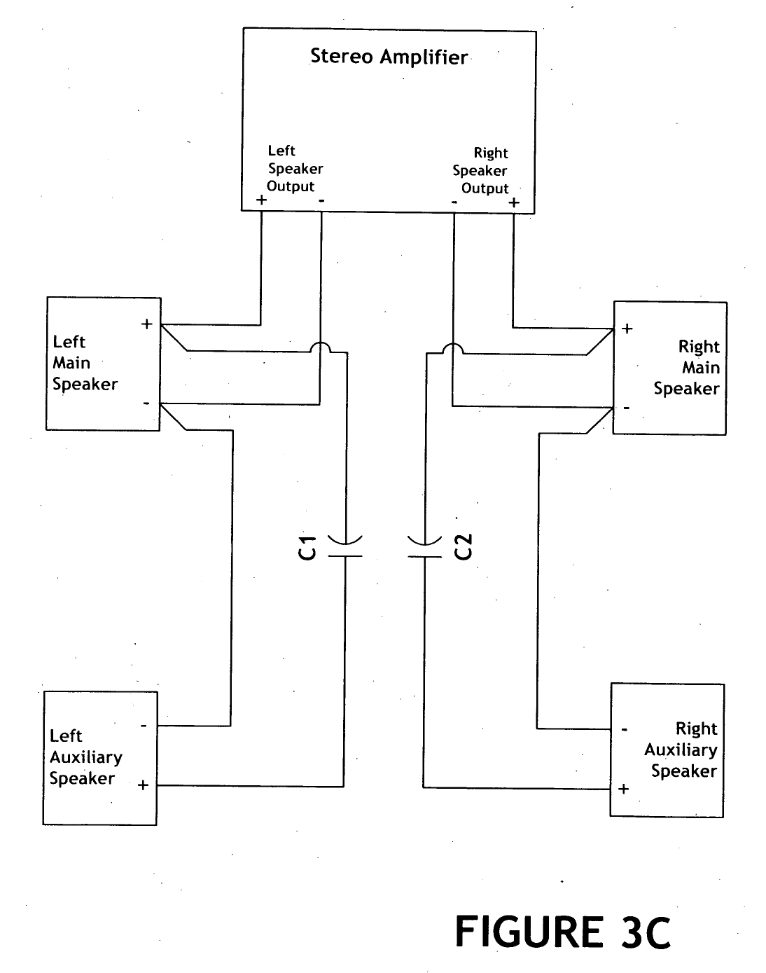

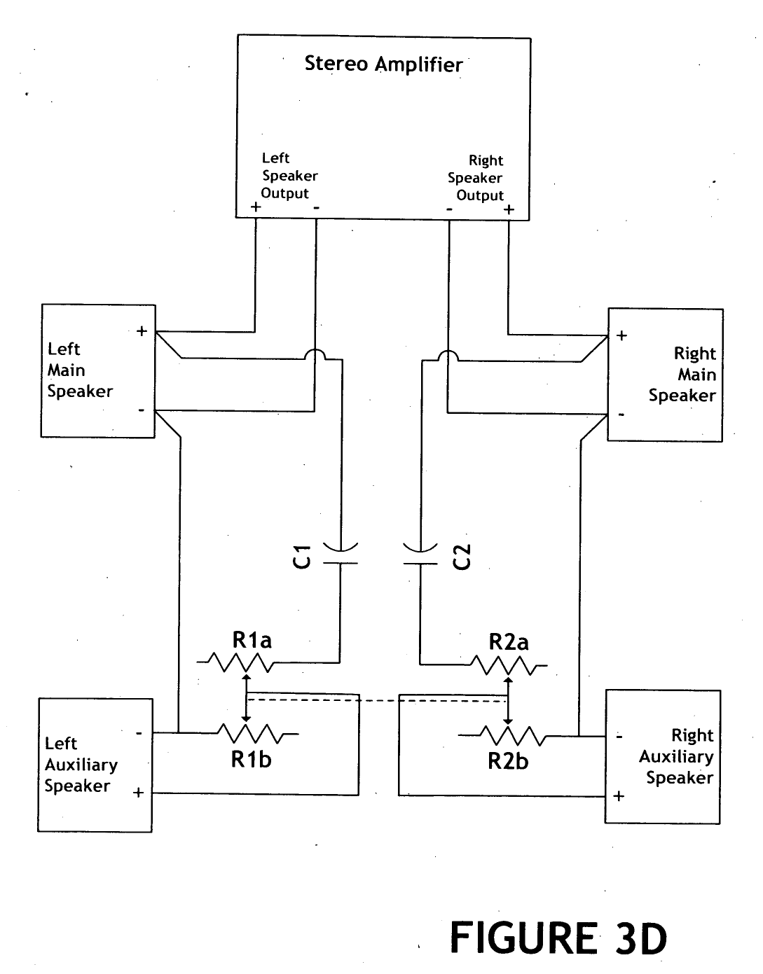

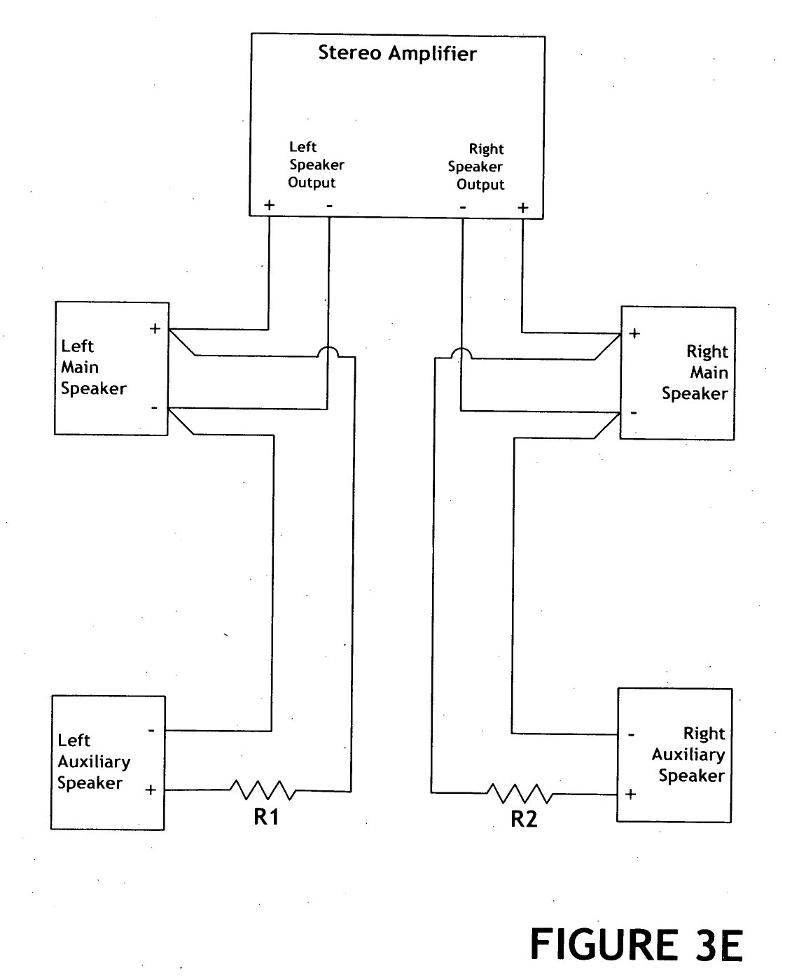

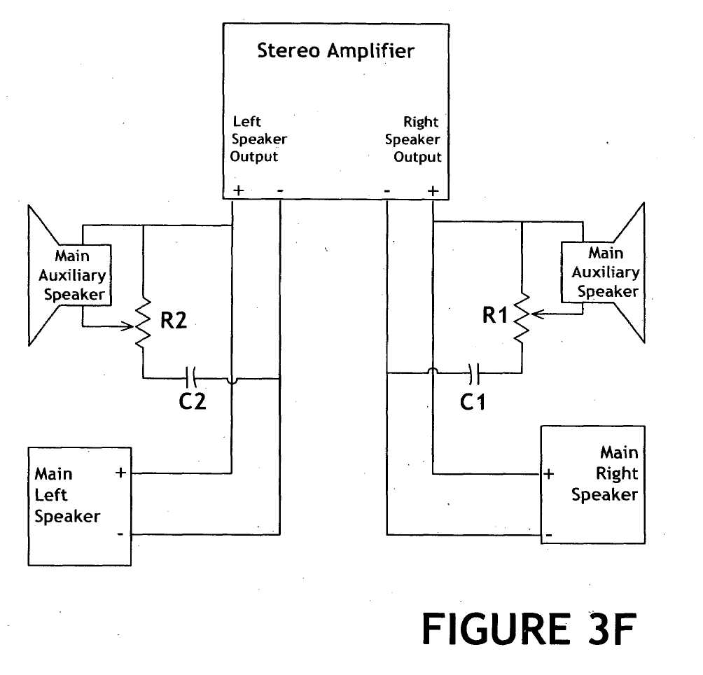

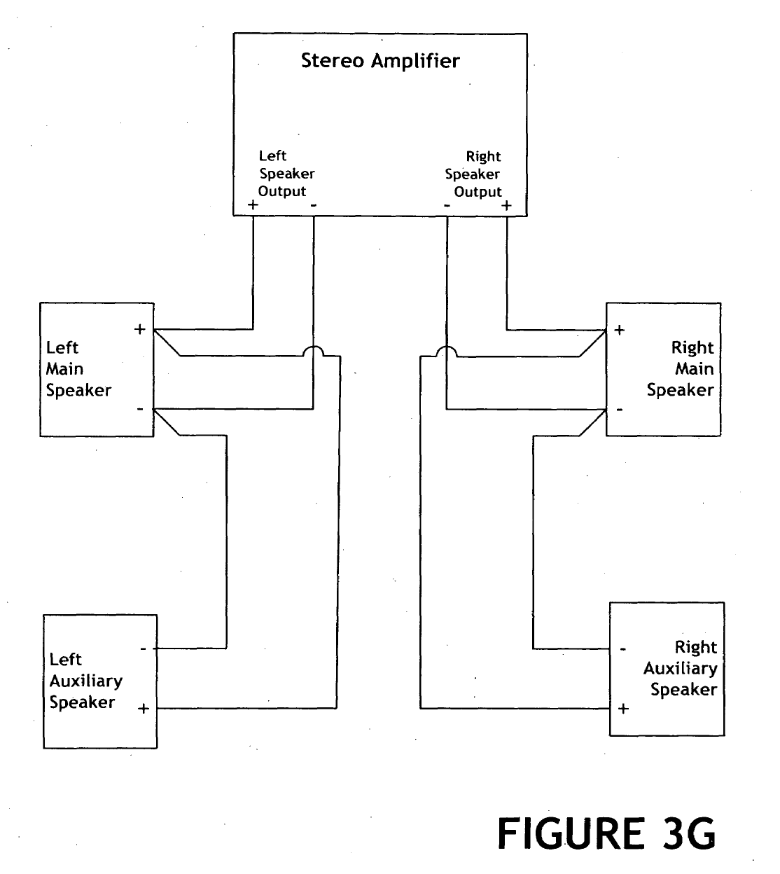

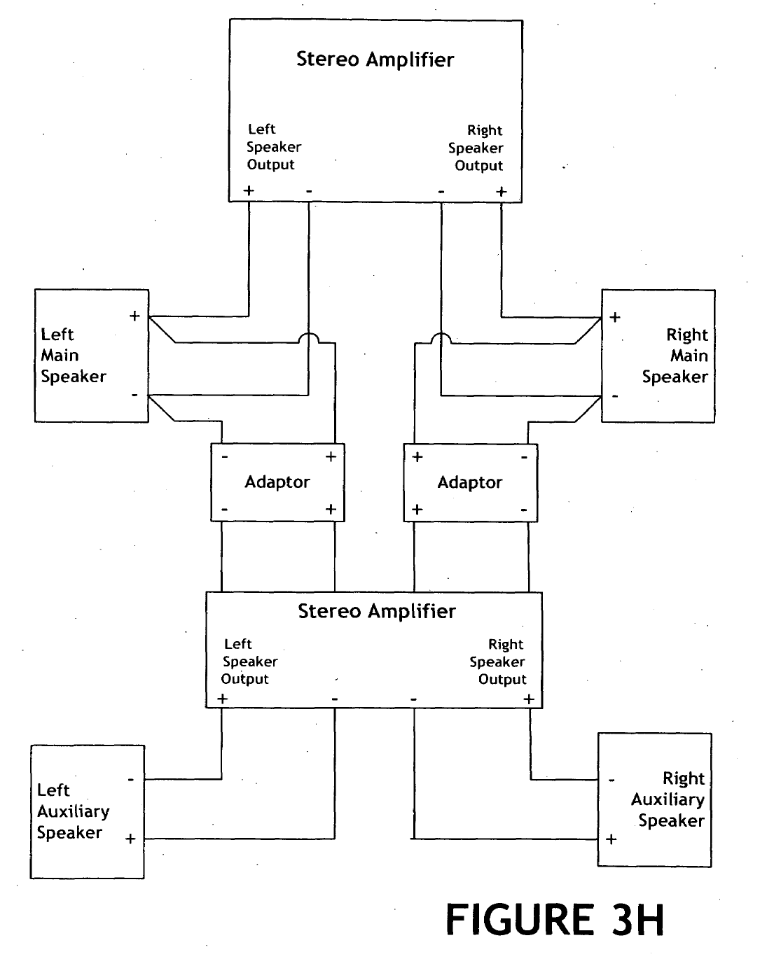

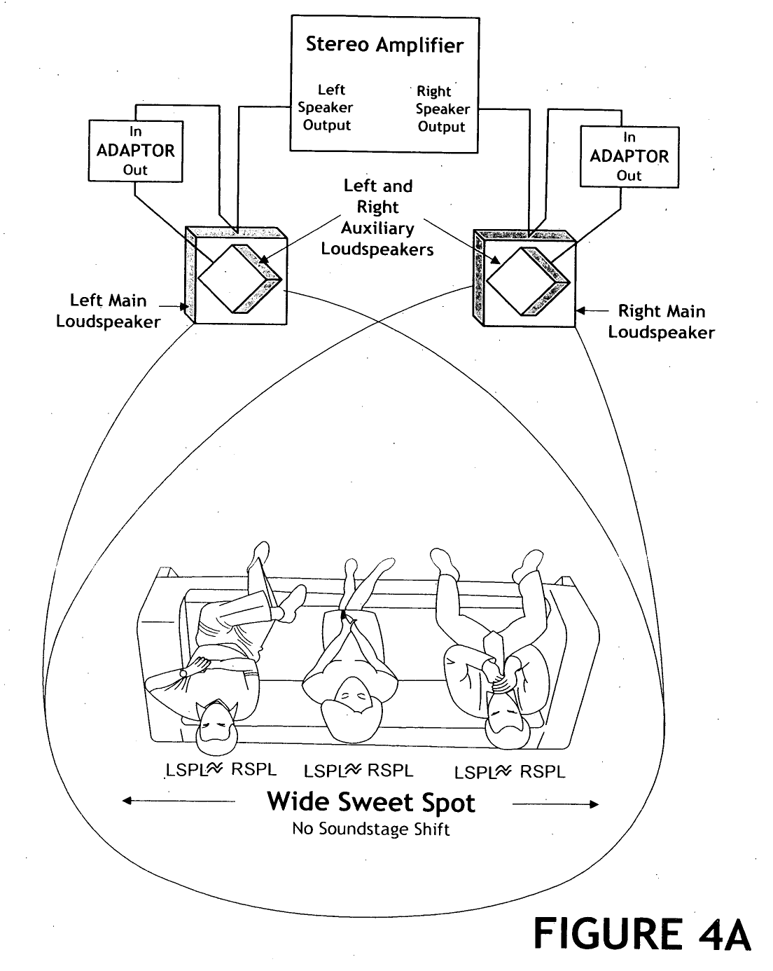

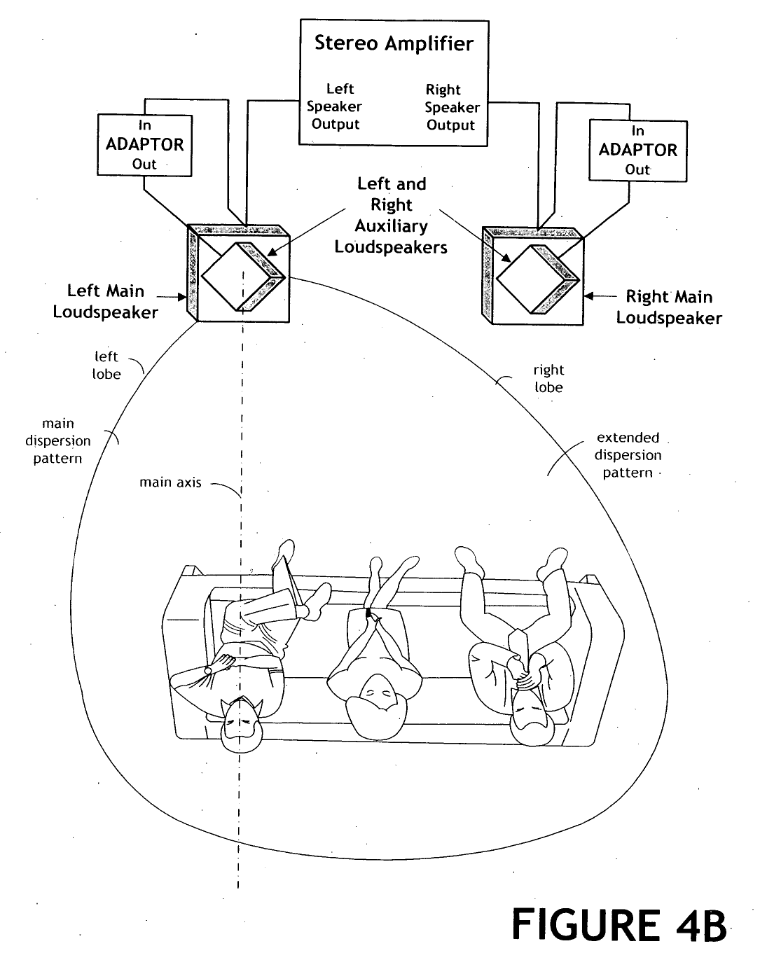

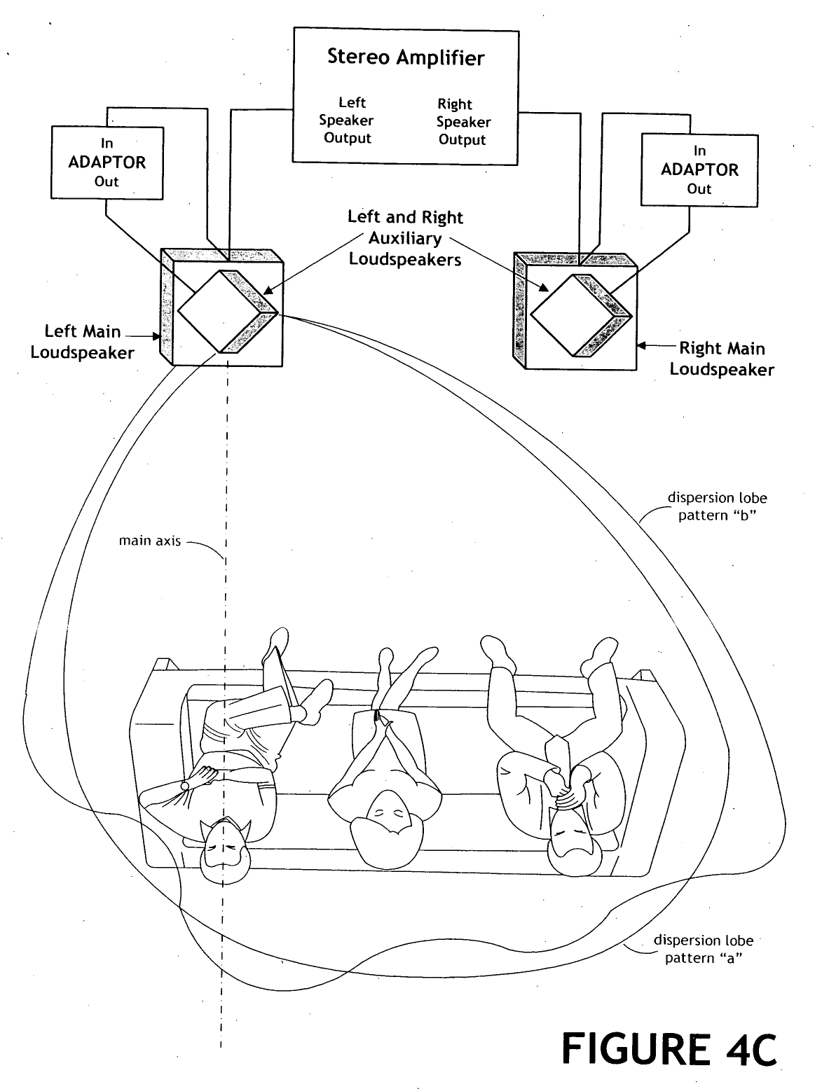

The invented process, carries out three specific post-amplification operations inside the adaptors and assisted by the auxiliary speakers (see the adaptor and the auxiliary speaker in FIGS. 1A and 3A), widens the stereophonic sweet spot, reduces soundstage shift (see wide sweet spot and no soundstage shift in FIGS. 1A and 4A), corrects off-axis response (see FIGS. 2B, 6A, 6B, 6C, and 6D) and improves off-axis phantom image specificity.

The invented process is useful because it improves stereophonic realism over and above the present art. Stereophonic “realism” is a subjective assessment of the degree to which the sound from an audio system approaches that of live music. To achieve these goals the process carries out the following three operations.

First, to block the low frequency audio power from being delivered to the auxiliary speakers as to prevent any low frequency phase mismatch or phase distortion between the auxiliary speakers and the main speakers, as depicted in FIG. 3C. Further prevent the auxiliary speakers from overloading the amplifier audio output circuits. Gain other benefits from blocking the low frequency power from the auxiliary speakers. A reduction of Doppler distortion in the auxiliary speakers is also achieved, along with a general overall improvement in auxiliary speaker sound quality.

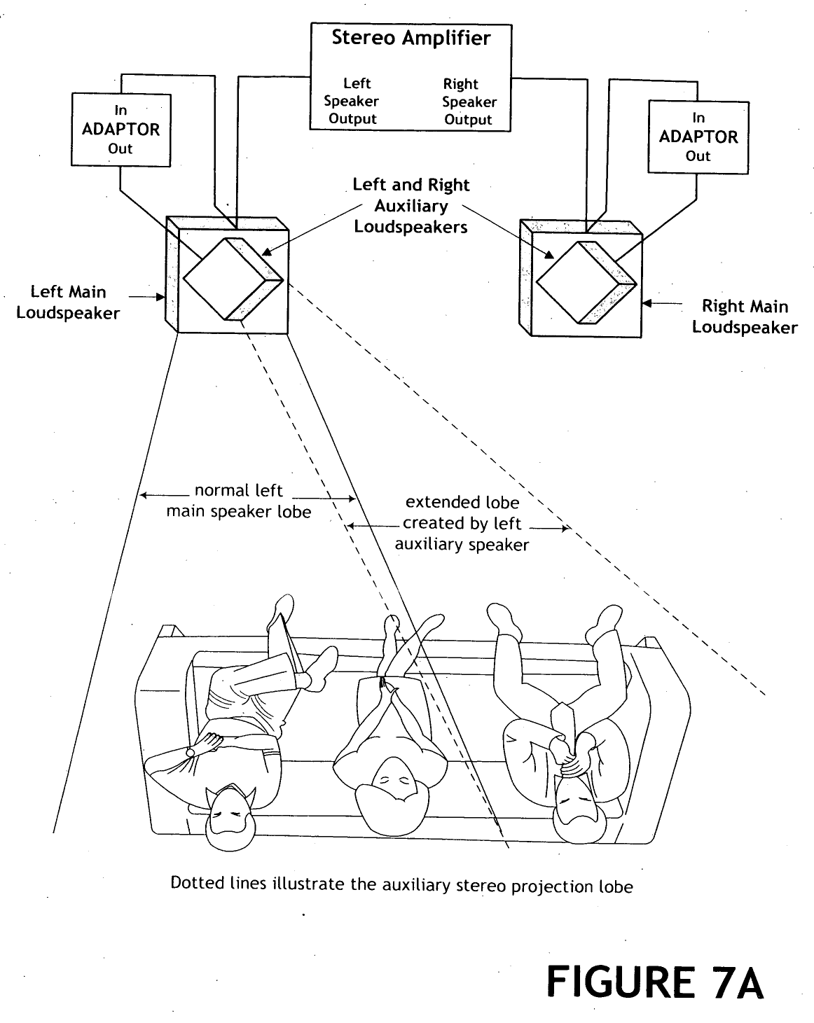

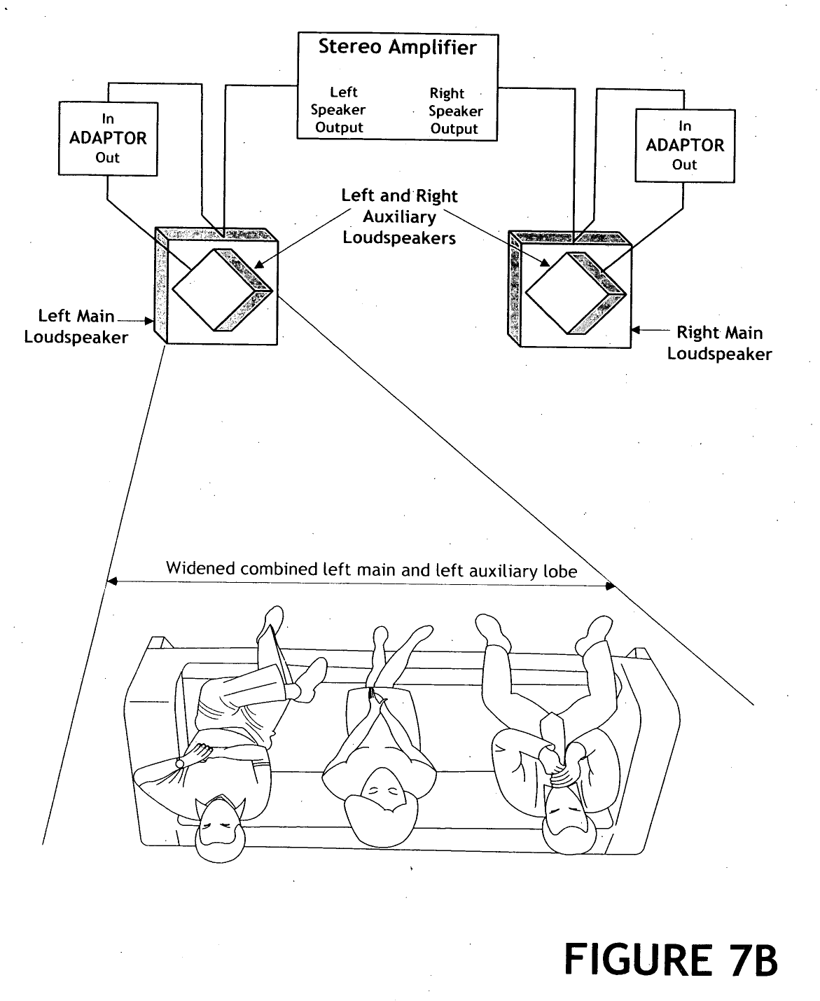

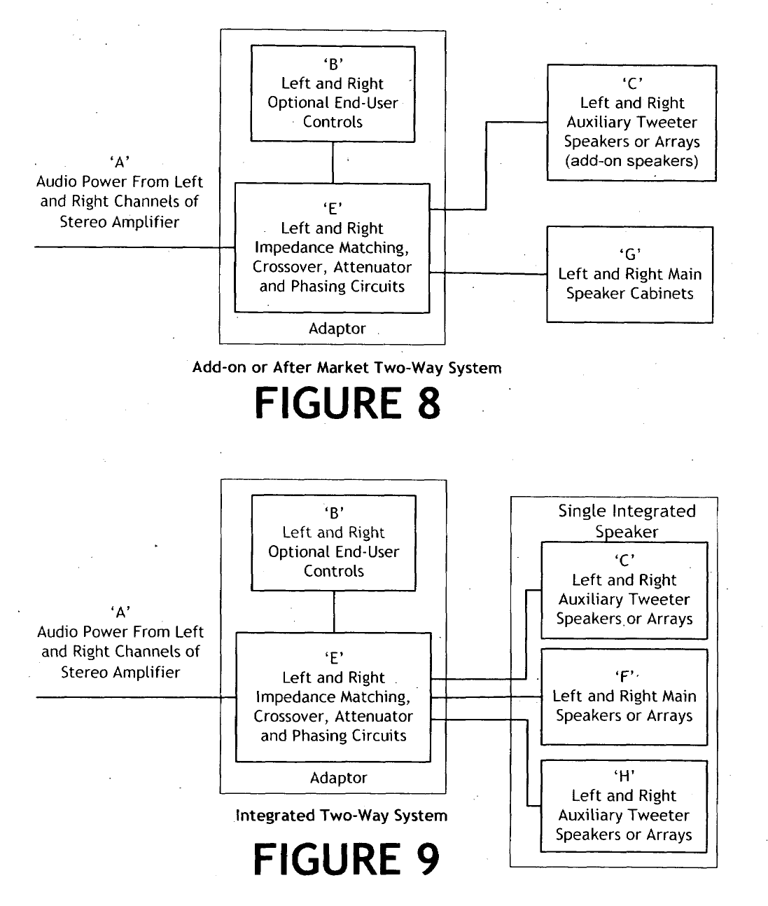

Second, depending on design and performance goals to attenuate (see FIG. 3E), the audio power level delivered to the auxiliary speakers relative to the audio power level delivered to the main speakers so that the sound pressure level radiated from the auxiliary speakers is less than or equal to the sound pressure level radiated from the main speakers such as to:
1. Produce the extended lobe effect shown in FIGS. 4B, 7A, and 7B.
2. Prevent the perceived sound pressure level from the auxiliary speakers from overpowering the perceived sound pressure level from the main speakers, as shown in FIG. 8B.
3. Prevent the auxiliary speakers from overloading the amplifier audio output circuits.

And, third, depending on design and performance goals, it may be desirable to control the acoustic dispersion pattern of the stereophonic sound system of the present invention, such as (a) to form a more uniform sound field over a large listening area; and (b) to optimize the dispersion pattern for any listening environment, as depicted in FIG. 4C.

FIG. 3A depicts a generic “post amplification” adaptor configuration. There are also many other “pre-amplification” circuit possibilities that would become known to one skilled in the art once proficient in the teachings of this invention. The one common element in all these variants is the mature invented process described herein.

FIGS. 6A and 6B represent a loudspeakers' off-axis response, showing the increasing loose of high frequencies with the increasingly off-axis position. In FIG. 6A the length of the arrows becomes shorter as the off-axis angle increases. This represents the increasing loose of high frequencies with the increase of the off-axis angle.

FIG. 6C shows a representation of the correction of off-axis response. Speaker 1 has strong on-axis projection line “a” and weak off-axis projection line “b.” Speaker 2 has strong on-axis projection line “d” and weak off-axis projection line “c.” Speakers 1 and 2 complement each other in that where speaker 1 is weak (projection line “b”), speaker 2 is strong (projection line “d”), where speaker 2 is weak (projection Line “c”), speaker 1 is strong (projection line “a”). Thus each speaker corrects the off-axis response for the other speaker.

FIG. 6D depicts yet another representation of the correction of off-axis response. This representation shows how the acoustic power emanating from speaker 3 and speaker 4 blend together to form a wider dispersion angle “e.”

FIG. 4B shows a representation of the combined left main speaker and left auxiliary speaker dispersion pattern. The dispersion pattern can be seen as asymmetrical with respect to the main axis. The pattern on the left side of the axis is normal for the main speaker. However, the pattern to the right of the axis has an extended dispersion pattern that now includes the listener in the right position.

In FIG. 3B, C1 and C2 are high-pass filters that block the low frequencies from the auxiliary speakers. R1 and R2 attenuate and limit the maximum audio power delivered to the auxiliary speakers. However, R1 and R2 increase the total load impedance seen by C1 and C2.

FIG. 4C depicts the dispersion pattern control, more particularly dispersion lobe patterns “a” and “b”. Using phase shift circuits to vary the phase relationship between the main speakers and the auxiliary speakers, the dispersion pattern can be shaped to meet the needs of a particular performance goal.

Each of the embodiments of the stereophonic sound system of the present invention receives audio power from a stereo amplifier, processes the audio power by carrying out said electronic operations and delivers the processed audio power to a pair of auxiliary speakers having their respective axes toed inward, as shown in FIG. 1A.

In FIG. 3C, C1 and C2 form high-pass filters that block the low frequencies from the auxiliary speakers.

In FIG. 3B, C1 and C2 are high-pass filters that block the low frequencies from the auxiliary speakers. R1 and R2 attenuate and limit the audio power delivered to the auxiliary speakers.

Referring now to FIG. 3C, this embodiment of the stereophonic sound system of the present invention has no resistive attenuation. The high frequency audio speaker power of the left and right main speaker is the same as high frequency the audio speaker power of the left and right auxiliary speakers. One such instance of no attenuation is where the listener is using auxiliary speakers that are less efficient than the main speakers. In this case, the power delivered to the main and auxiliary speakers will need to be equal but the radiated sound pressure level from the auxiliary speakers will be less due to inefficiency than the radiated sound pressure level from the more efficient main speakers. This is a case of mechanical attenuation where no electrical resistive attenuation is needed. Of course, if a listener uses the less efficient speakers as the main speakers then electrical resistive attenuation of the auxiliary speakers is required. Another instance where the listener just prefers equal sound pressure level radiated from both the main speakers and the auxiliary speakers.

In FIG. 3D, R1a-R1b are mechanically connected to R2a-R2b by a common armature, depicted as a dotted line. R1 and R2 are configured as “L” pads. In this instance, R1 and R2 represent a constant 8Ω impedance to C1 and C2, thus maintaining the designed crossover point.

In FIG. 3E, series resistors R1 and R2 attenuate and limit the maximum audio power delivered to the audio speakers. R1 and R2 also lighten the load placed on the stereo amplifier output circuits, thus helping to prevent overloading. FIG. 3E also depicts the relevant parts of a stereophonic sound system using two or more small “cube” type “satellite” midrange and tweeter main speaker cabinets with a separate single large subwoofer (not shown). The manufacturer of the stereo amplifier has included internal pre-amplification high pass filters functionally identical to (albeit for a different purpose) the high pass filters described in the present invention. The auxiliary speakers of FIG. 3E are wired directly to and in parallel with the main speakers with the audio power being attenuated by series attenuation resistors R1 and R.

FIG. 3F refers to a simplified schematic diagram of a preferred embodiment of the stereophonic sound system of the present invention. C1 forms a first order 6 db per octave high-pass filter circuit. R1 (8Ω L-Pad) forms an attenuator network. The high-pass filter circuit isolates the low frequency power from the auxiliary tweeter while the attenuator attenuates the audio power delivered to the auxiliary tweeter. Right channel audio power is supplied from the right channel output of the stereo amplifier to the right main speaker. Right channel audio power is also supplied from the right channel output of the stereo amplifier to the high-pass filter C1. The high-pass filter blocks the low frequencies and pass the high and midrange frequencies on to the attenuator formed by R1 and R2. The attenuator reduces the audio power and delivers it to the right auxiliary tweeter.

FIG. 3G depicts the relevant parts of a stereo system scheme using two or more small “cube” type “satellite” midrange and tweeter main speaker cabinets with a separate single large subwoofer, which is not shown. The manufacturer of the stereo amplifier includes internal pre-amplification high pass filters functionally identical to, albeit for a different purpose, the high pass filters described in the present invention. The auxiliary speakers are wired directly to, and in parallel with, the main speakers without the audio power being attenuated. In this embodiment the adaptor is not needed.

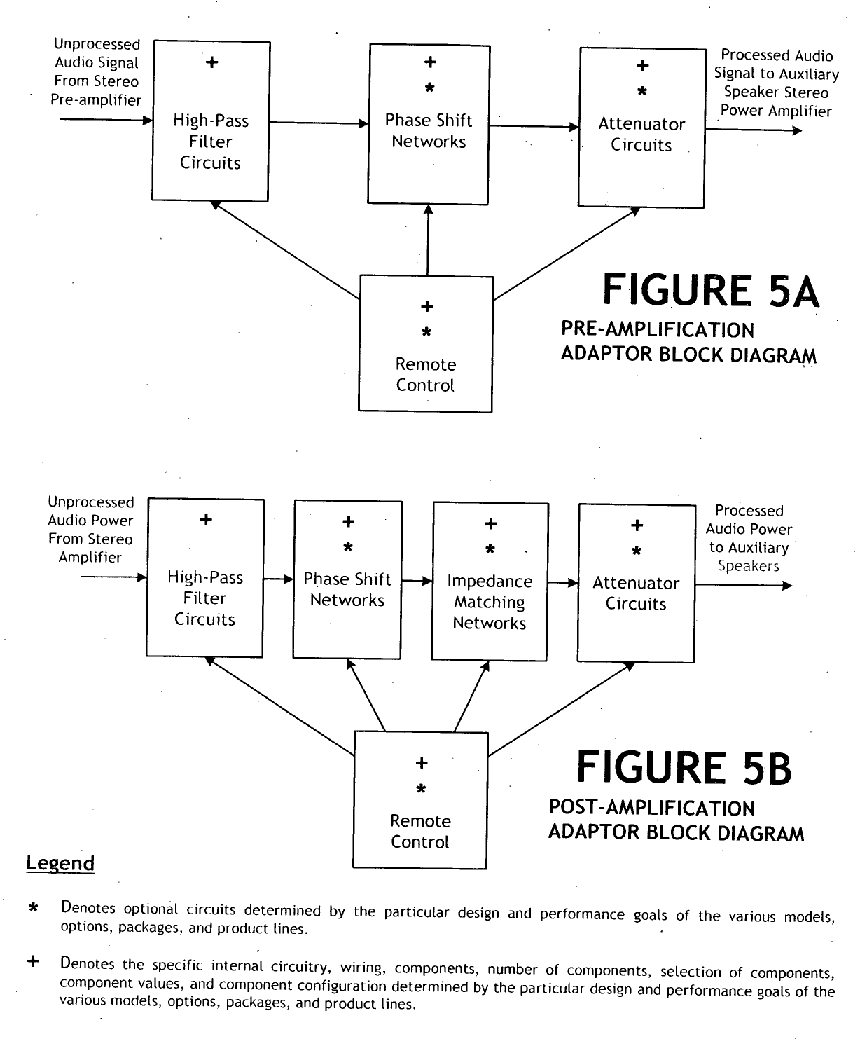

FIGS. 5A and 5B depict the various stages inside an adaptors. Full spectrum audio power, from the amplifier output circuit, enters the adaptor and flows to the high-pass filter. The high-pass filter passes the high frequency audio power to and blocks the low frequencies from the next stage. Blocking the low frequencies reduces the power requirements for the remaining stages and for the auxiliary speaker. This helps reduce the cost. The reduction in power requirements and cost is especially true for any inductive components.

FIG. 5A depicts a pre-amplification adaptor. Full spectrum unprocessed audio signal from stereo preamplifier enters the adaptor and flows to the high-pass filter. The high-pass filter passes the high frequency audio power to and blocks the low frequencies from the next stage. Blocking the low frequencies reduces the power requirements for the auxiliary speaker. This helps reduce the cost.

From the high-pass filter the remaining audio signal then flows to the optional phase shift circuit. The phase shift circuit alters the electrical phase of the audio power delivered to the auxiliary speaker with respect to the main speaker.

The audio power then flows to the optional attenuator network. The attenuator network reduces the audio power delivered to the auxiliary speakers. Then the fully processed audio signal flows to the output 2, and on to the auxiliary speaker.

The choice of high-pass fitter type, phase shift type and attenuation network depends on the design goats, performance goals, and other real world considerations for the various product models, options packages and product lines. The inclusion or omission of the several above mentioned circuits will also be based on the design goats, performance goals, and other real world considerations for the various product models, options packages and product lines.

FIG. 5B depicts a post-amplification adaptor. Full spectrum audio power, from the amplifier output circuit, enters the adaptor and flows to the high-pass filter. The high-pass filter passes the high frequency audio power to and blocks the tow frequencies from the next stage. Blocking the tow frequencies reduces the power requirements for the remaining stages and for the auxiliary speaker. This helps reduce the cost.

From the high-pass filter the remaining audio power then flows to the optional phase shift circuit. The phase shift circuit alters the electrical phase of the audio power delivered to the auxiliary speaker with respect to the main speaker.

The audio power then flows to the optional impedance matching circuit and optional attenuator network. The attenuator network reduces the audio power delivered to the auxiliary speakers. The impedance matching circuit presents a high impedance load to the power output circuit of the amplifier and serves as a low impedance audio power source to the auxiliary speaker. Then the fully processed audio power flows out of the adaptor to the auxiliary speaker.

The choice of high-pass fitter type, phase shift type, impedance matching method and attenuation network depends on the design goals, performance goals, and other real world considerations for the various product models, options packages and product lines. The inclusion or omission of the several above mentioned circuits will also be based on the design goals, performance goals, and other real world considerations for the various product models, options packages and product lines.

Referring now to FIGS. 8 and 9, for two-way after-market, integrated two-way, respectively. The particular adaptor ‘E,’ including a crossover network, attenuator circuit, impedance matching network or the phasing circuits (phasing circuits control the phase angle relationship between the audio power delivered to the main speakers or arrays and the audio power delivered to the auxiliary speakers or arrays), or any combination thereof, used in any particular model, options package or product line, may be in whole or in part generic or an off the shelf item or may be in whole or in part specifically engineered for a particular model, options package, or product line.

Depending on the particular model, options package and product line, any of several end user control mechanisms ‘B’ may be included. The particular circuit ‘B’ may be in whole or in part a generic off-the-shelf item or may be in hole or in part specifically engineered for a particular model, option package, or product line. Such variations as described above with respect to crossover network, attenuator circuit, impedance matching network, phasing circuits and end user control circuits, may be made therein, without departing from the spirit and scope of the invention.

Audio power ‘A’ is supplied from the left and right channels of the stereo amplifier to the impedance matching, crossover, attenuator and phasing circuits ‘E’. Adaptor circuits ‘E’ deliver full spectrum audio power directly to the left and right main speaker cabinets ‘G’ while at the same time directing equal or less of the high and midrange frequency power to the auxiliary tweeter speakers or arrays ‘C’. Adaptor circuits ‘E’ includes a high-pass filter type crossover network and an optionally attenuator circuit. Optionally, adaptor circuits ‘E’ may also include an impedance matching network or phasing circuits.

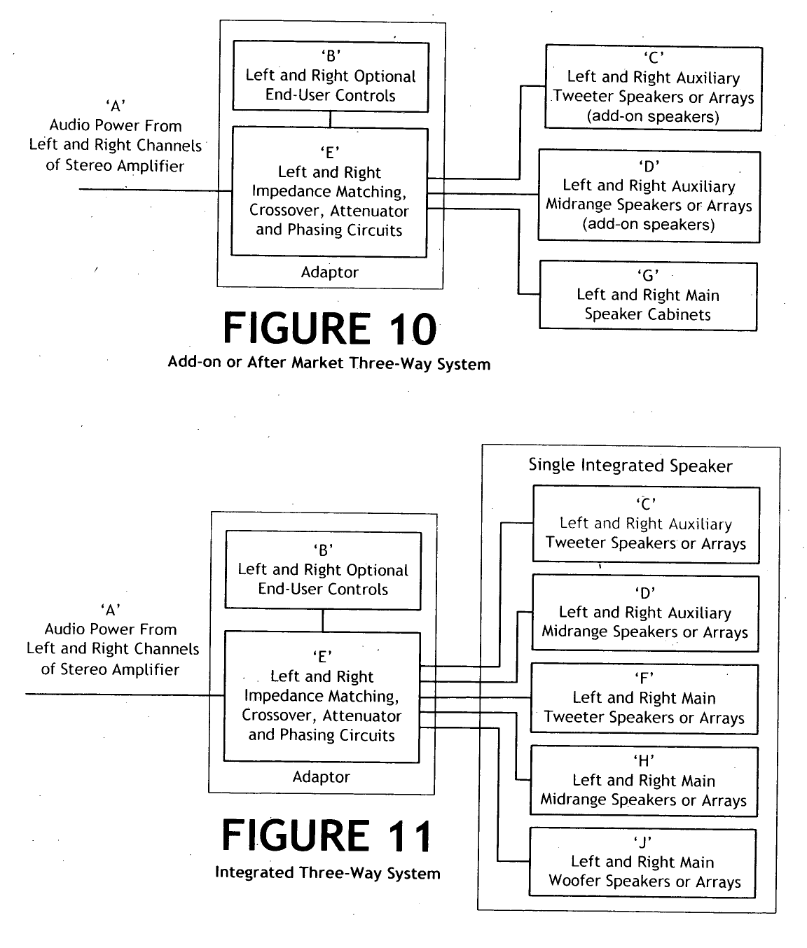

FIG. 10 depicts a preferred embodiment of add-on or after-market three-way, audio power stereophonic sound system of the present invention, the audio power ‘A’ is supplied from the left and right channels of the stereo amplifier to the impedance matching, crossover, attenuator and phasing circuits ‘E.’ Adaptor circuits ‘E’ deliver equal or less high frequency power to the left and right auxiliary midrange speakers or arrays ‘D’, and an equal or less amount of high frequency power to the left and right auxiliary tweeter speakers or arrays ‘C’. Adaptor circuits ‘E’ have, depending on the particular model, options package and product line, one or two high-pass filter type crossover networks and an attenuator circuit. Adaptor circuits ‘E’ deliver full spectrum audio power directly to the left and right main speaker cabinets ‘G’. Adaptor circuits ‘E’ also deliver a small amount of high frequency audio power to the left and right auxiliary tweeter speakers or arrays ‘C’ and a small amount midrange audio power to the left and right auxiliary midrange speakers or arrays ‘D’. Optionally, the adaptor circuits ‘E’ also include an impedance matching network or phasing circuits.

FIG. 11 depicts a preferred embodiment of integrated three-way audio power stereophonic sound system of the present invention, the audio power ‘A’ is supplied from the left and right channels of the stereo amplifier to the impedance matching, crossover, attenuator and phasing circuits ‘E’. Adaptor circuits ‘E’ deliver low frequency audio power to the left and right main woofer speakers or arrays ‘J’. Adaptor circuits ‘E’ deliver midrange (200 Hz to 8,000 Hz) frequency power to the left and right main tweeter speakers or arrays ‘H’. Adaptor circuits ‘E’ deliver high frequency power to the left and right main tweeter speakers or arrays ‘F’. Adaptor circuits ‘E’ deliver equal or less high frequency power to the left and right auxiliary midrange speakers or arrays ‘D’, and an equal or less amount of high frequency power to the left and right auxiliary tweeter speakers or arrays ‘C’. Adaptor circuits ‘E’ has, depending on the particular model, options package and product line, one or two high-pass filter type crossover networks, a midrange pass filter type crossover network, and an attenuator circuit.

Adaptor circuits ‘E’ of FIGS. 8, 9, 10, and 11 include, depending on the particular model, options package and product line, one or two high-pass filter type crossover networks, one or two midrange, filter type crossover networks, a low pass filter type crossover network and an attenuator circuit. Optionally, adaptor circuits ‘E’ may also include an impedance matching network or phasing circuits. The phasing circuits control the phase angle relationship between the audio power delivered to the main speakers or arrays and the audio power delivered to the auxiliary speakers or arrays. Although the present invention has been shown and described with respect to several preferred embodiments thereof, various changes, omissions and additions to the form and detail thereof, may be made therein, without departing from the spirit and scope of the invention.

The following adaptor circuit diagrams are the practical schematic diagrams describing the invention, herein referred to as “adaptor.” Each diagram represents one of two identical circuits; one circuit serves the left channel speaker system and the other circuit serves the right channel speaker system.

In all of the following diagrams the dotted lines represent the chassis or enclosure that houses the electronic components. Such chassis or enclosure may house just the components, circuit boards, controls and connectors as one or more stand-alone units or such chassis or enclosure may be integrated into an audio amplifier or such chassis or enclosure may be integrated into a loudspeaker cabinet. In the adaptor circuits and configurations for purposes of illustration only, audio power from the amplifier speaker output flows to the main speakers, and also flows into the adaptor through socket, S1, which is electrically engaged with plug, P1. The processed audio power exits the adaptor and flows into the auxiliary speaker through 52 and P2. Also, audio current flows into the adaptor through pin 1 of S1 and pin 1 of P1, and returns to the audio amplifier through pin 2 of P2, S2, P1, and S1. The audio power flows from the audio amplifier to S1 to P1 to the adaptor to S2 to P2 and to the auxiliary speaker. In addition, the audio voltage from the amplifier output is applied to the adaptor through the two pins of S1 and the two pins of P1, and exits the adaptor through the two pins of S2 and the two pins of P2.

All of the following embodiments are shown with first order 6 db per octave high-pass filter circuit designated with the letter F or C1. However, such adaptors can also be produced with second order, third order or fourth order high-pass filters as well as first order, second order, third order or fourth order band-pass filters.

Variations in embodiments include high-pass filters (1) first order, (2) second order, (3) third order, (4) fourth order high-pass filters, and (5) no high-pass filter in the case of piezoelectric tweeters. Because piezoelectric tweeters present a capacitive load to an amplifier they act as their own high-pass filters. Some filters are symbolized below as a box designated with the letter F and some filters are symbolized below by C1. The letter F is used to represent any one of the five high-pass filter possibilities described above.

Other variant include maximum power rating for each adaptor: such as 20 watt units, 50 watt units, 100 watt units and 250 watt units. At the time of this writing, there are five fitter variants, times four power variants for a subtotal of 20 circuits variants for each of the following 57 adaptor diagrams, some of which are not shown.

All the following circuits are shown and described as post-amplification adaptors only. In all the following circuits, audio power is first applied to passive high-pass filter F. The low frequency current is blocked by F. Applying audio power first to F reduces the power requirements for the following impedance matching and attenuator circuits. This helps reduce the cost of these components. The choice of filter type, impedance matching method and attenuation network depends on the design goals, performance goals, desired phase relationship between the main loudspeakers and the auxiliary loudspeakers, product model, options package and product line.

In all of the following fitter circuits and adaptor circuits the particular selected electrical values for the electronic components are dependant on the design and performance goals of the particular model, options package and product line produced.

Although the present invention has been shown and described with respect to the several preferred embodiments thereof, various changes, omissions and additions to the form and detail thereof, may be made therein, without departing from the spirit and scope of the invention.

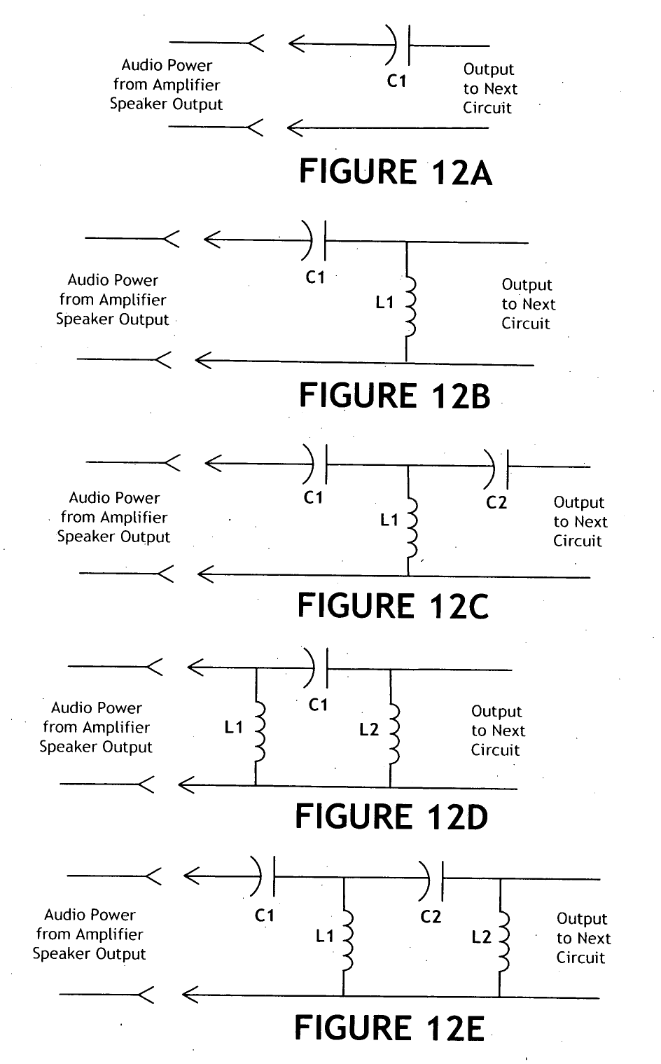

FIGS. 12A through 12E depict various preferred embodiments of 1^{st} order, 2^{nd} order, 3^{rd} order, and 4^{th} order high-pass filters for the stereophonic sound system of the present invention. FIG. 12A depicts a 1^{st} order high-pass filter having a 90° phase shift. FIG. 12B depicts a 2^{nd} order high-pass filter having a 180° phase shift. FIG. 12C depicts a “T” circuit 3d order high-pass fitter having a 270° phase shift. FIG. 12D depicts a “Pi” 3^{rd} order high-pass phase circuit having a 270° phase shift. And, FIG. 12E depicts a 4^{th} order high-pass fitter having a 360° phase shift.

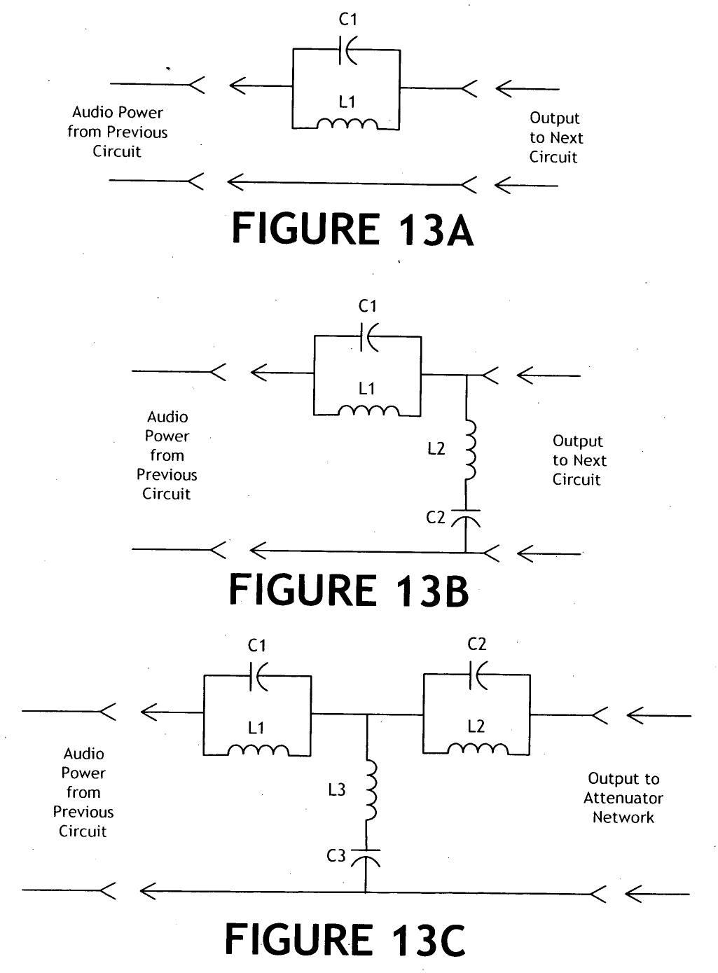

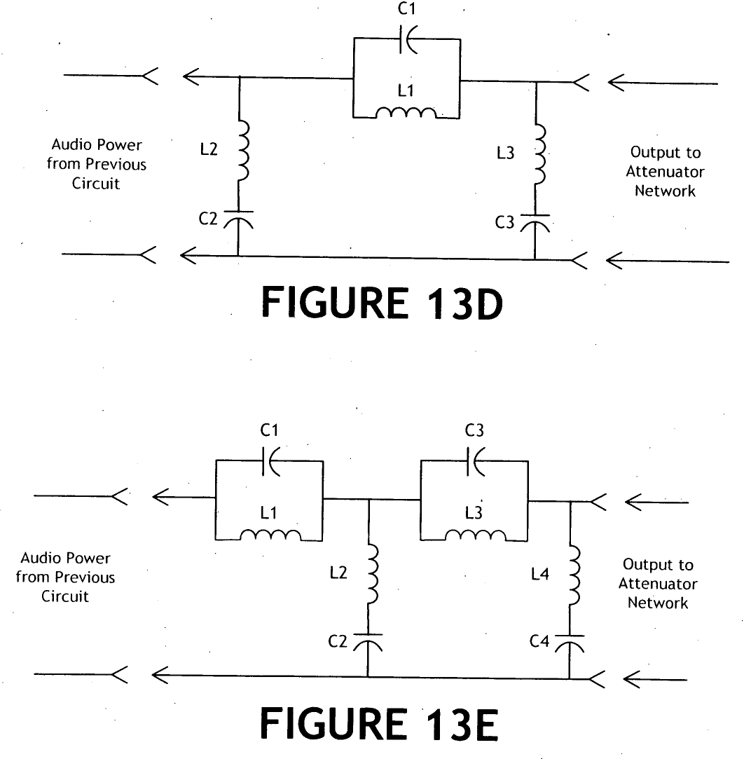

Referring now to FIGS. 13A, 13B, 13C, 13D, and 13E, there is shown five different preferred embodiments of phase shift networks known as all-pass filters, for use in the various adaptor circuits of the present invention. An all pass filter is a filter whose amplitude response is flat (within the bandwidth limitation of the amplifier), and which has a 90° phase shift at the “corner” frequency.

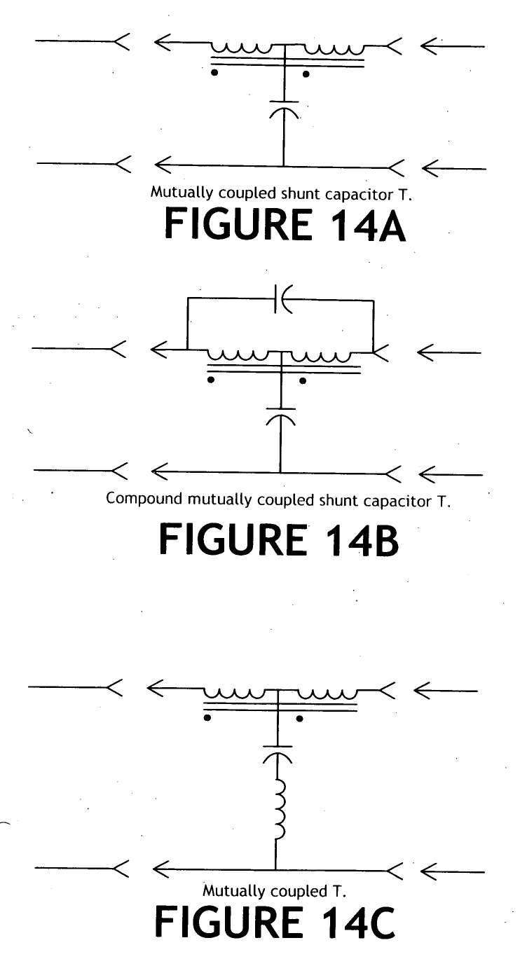

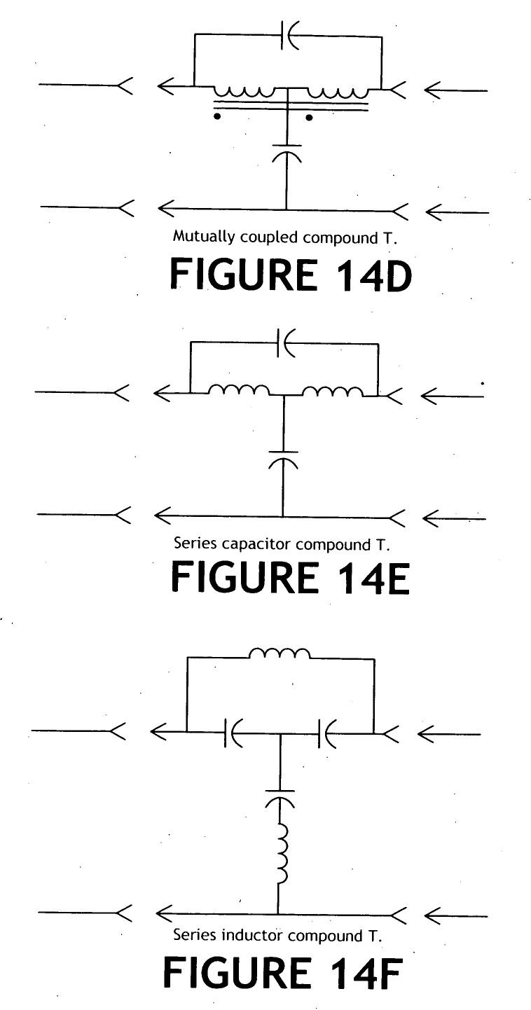

Referring now to FIGS. 14A, 14B, 14C, 14D, 14E, and 14F, there is shown six additional preferred embodiments of phase shift networks for use in the various adaptor circuits of the present invention. FIG. 14A depicts a coupled shunt capacitor phase shift network, FIG. 14B depicts a compound mutually coupled shunt capacitor phase shift network, FIG. 14C depicts a mutually coupled phase shift network, FIG. 14D depicts a mutually coupled compound phase shift network, FIG. 14E depicts a series capacitor phase shift network, and FIG. 14F depicts a series inductor compound phase shift network.

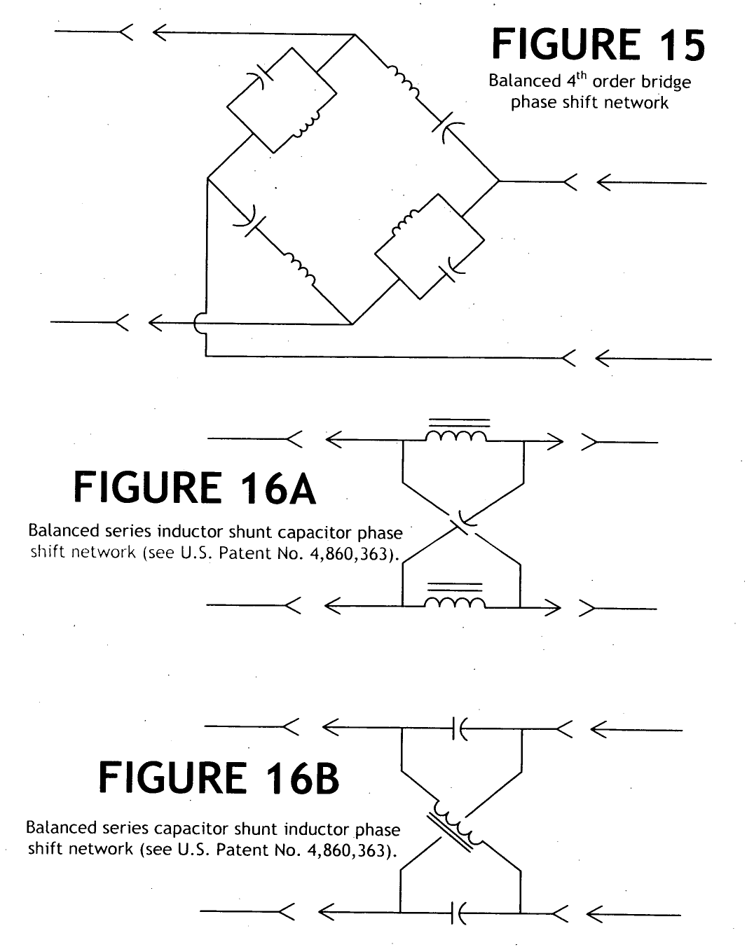

FIG. 15 discloses yet another phase shift network for the stereophonic sound system of the present invention, the phase shift network being a balanced 4th order bridge. FIGS. 16A and 16B disclose two different shunt capacitor phase shift networks that are compatible with the stereophonic sound system of the present invention that are shown in U.S. Pat. No. 4,860,363.

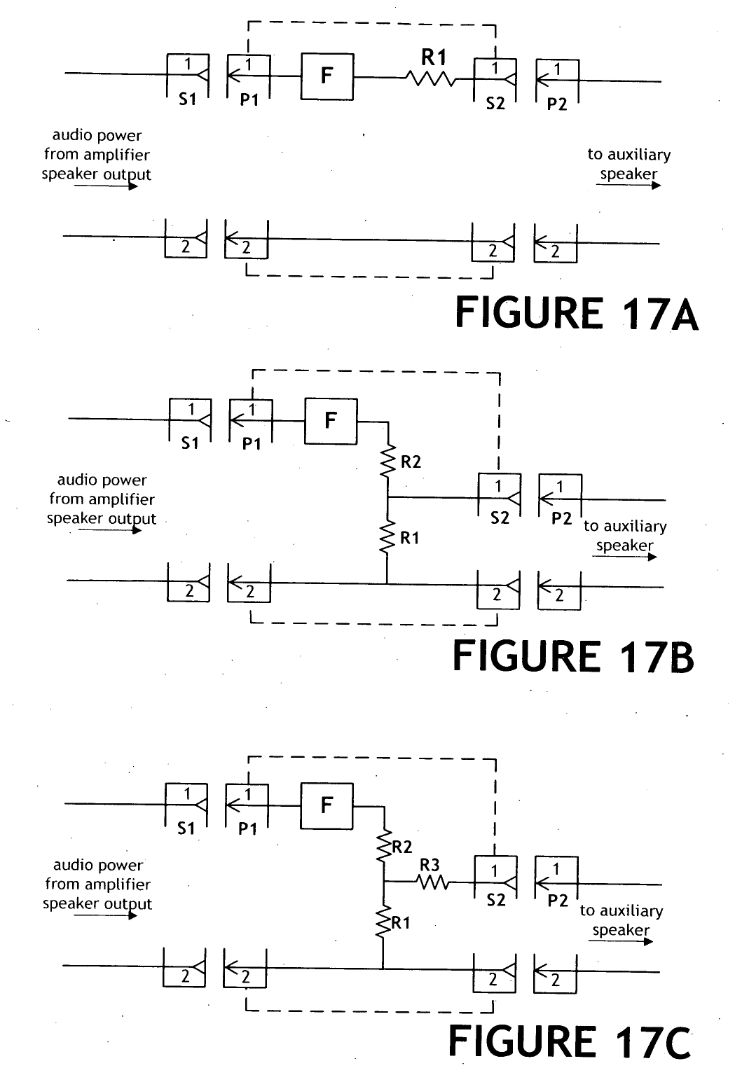

FIGS. 17A, 17B and 17C depict various preferred embodiments of factory preset static passive attenuators for the stereophonic sound system of the present invention. FIG. 17A is configured with a high pass fitter F (F1 or F2 or F3 or F4) and a factory preset resistive attenuator formed by series resistor R1. The high frequency current flows through F, R1 and the auxiliary tweeter and returns to the audio amplifier by the path described above. R1 and the auxiliary tweeter form a voltage divider type attenuator network so that the voltage across the auxiliary tweeter is less than the total voltage supplied by the audio amplifier.

FIG. 17B is configured with a high pass filter F and a factory preset resistive attenuator network formed by series resistor R1 and shunt resistor R2. The high frequency current flows through F and the voltage divider type attenuator network formed by R1 and R2. The attenuated audio voltage across R2 is applied through S2, P2 to the auxiliary tweeter. Audio current flowing through R1 and R2, and the audio current flowing through the auxiliary tweeter returns to the audio amplifier by the path described above. R1+R2=8Ω, where R1>R2, for example R1=2Ω and R2=6Ω. The particular selected electrical values for the electronic components in the above circuit are dependant on the design and performance goals of the particular model, options package and product line produced.

FIG. 17C is configured with a high pass filter F and a factory preset resistive “T” type attenuator network formed by series resistors R2 and R3 and shunt resistor R2. R2 limits the maximum audio power delivered to the auxiliary tweeter. R2 also reduces the power requirements for and cost of R1 and when necessary helps match the amplifier impedance to the auxiliary tweeter impedance. P3 limits the maximum audio power delivered to the auxiliary tweeter and when necessary helps match the amplifier impedance to the auxiliary tweeter impedance.

The high frequency current flows through F and the voltage divider type attenuator network formed by R1 and R2. R3 is also a series current limiting resistor to provide some protection for the auxiliary tweeter. The audio voltage across R2 is applied through S2, P2 to the auxiliary tweeter. Audio current flowing through R1 and R2, and the audio current flowing through the auxiliary tweeter returns to the audio amplifier by the path described above.

R1+R2=8Ω, where R1>R2, for example R1=2Ω and R2=6Ω. The particular selected electrical values for the electronic components in the above circuit are dependant on the design and performance goals of the particular model, options package and product line produced. Distributing the power dissipation between R1 and R2 reduces the power requirements for and cost of both.

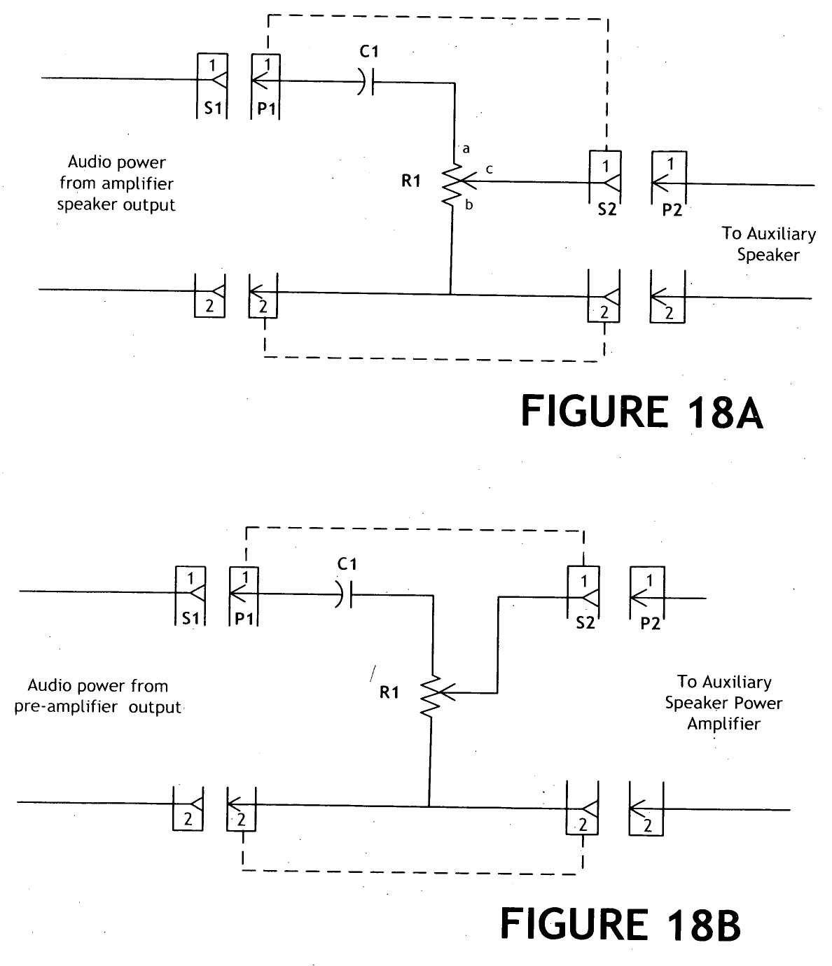

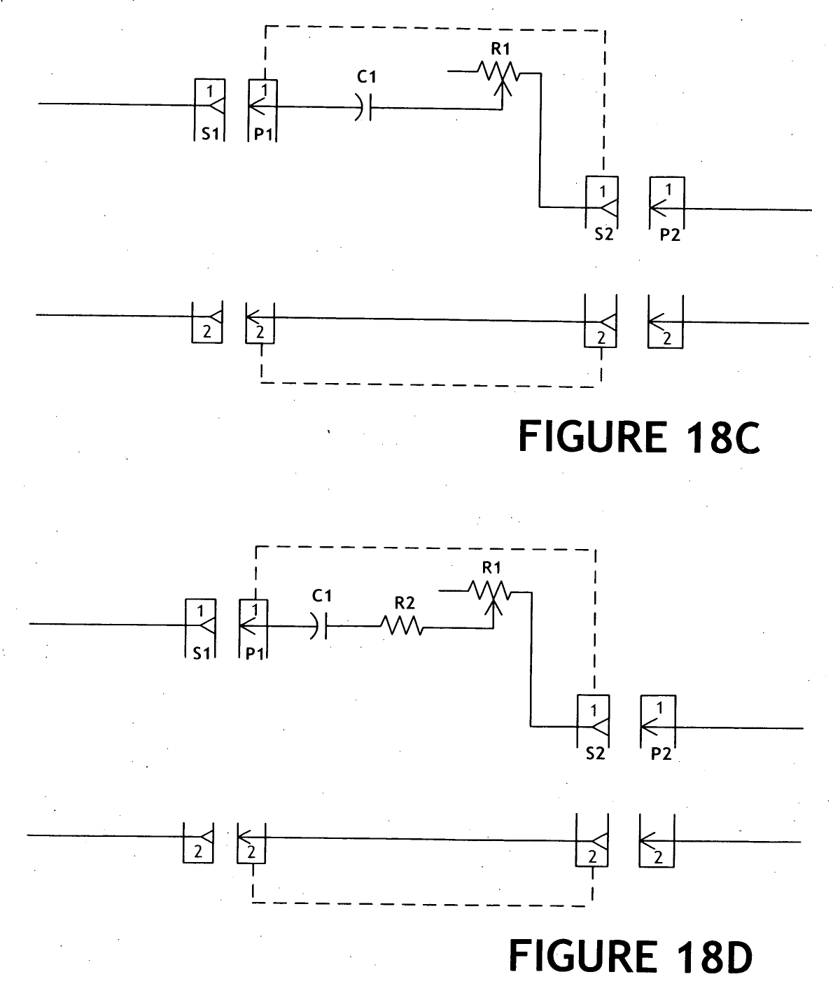

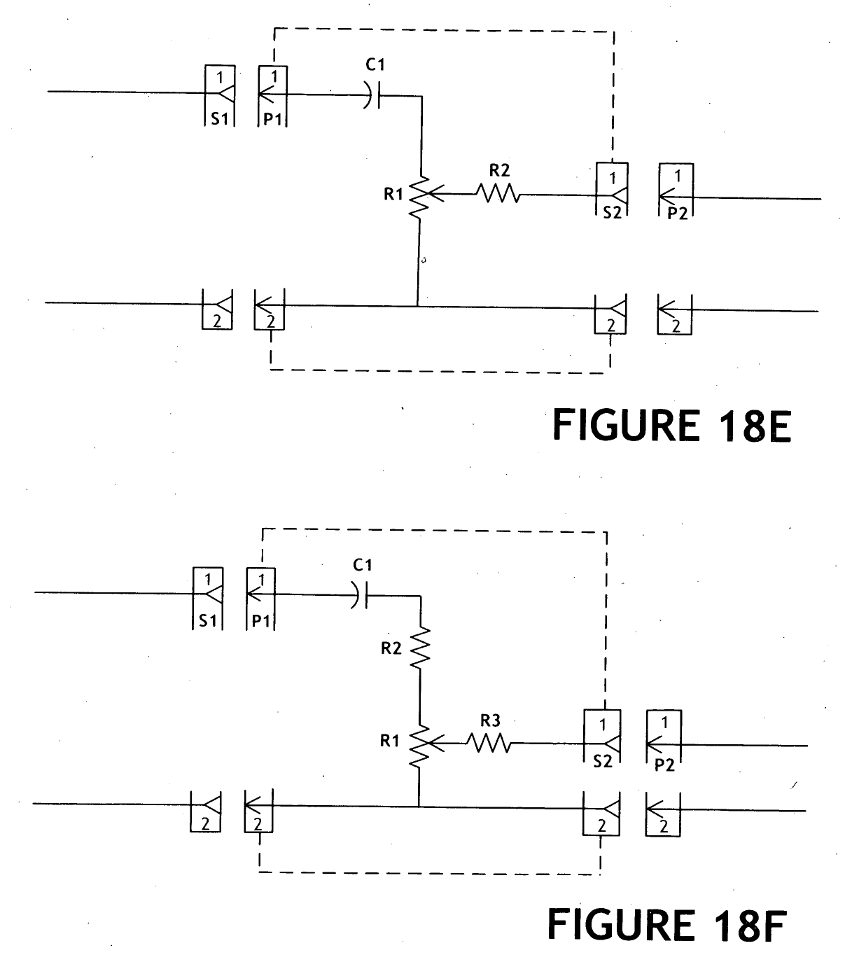

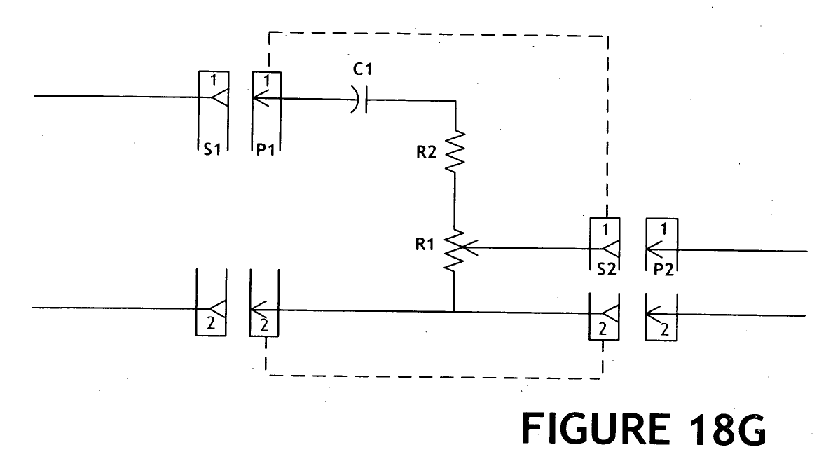

FIG. 18A depicts one channel of a two channel stereo best mode pre-amplification embodiment. C1 and R1 form an L-C type high-pass filter circuit. The high-pass filter circuit blocks low audio frequency power from the auxiliary speaker amplifier and attenuates the middle frequency audio power delivered to the auxiliary speaker. R1 can be a fixed resistor, or as shown here, a variable potentiometer. A variable potentiometer for R1 allows adjustment of the audio power delivered to the auxiliary speaker to suit individual psychoacoustic preferences, variations in speaker sensitivities and efficiencies, variations in listening room acoustical characteristics and other real world variables.

FIG. 18B shows one channel of a two channel stereo best mode post-amplification embodiment. This embodiment is configured with a high-pass filter C1 and a variable resistive L-pad attenuator R1. The circuit receives full spectrum audio power from the amplifier speaker output through S1 and P1. C1 blocks the low frequency part of the audio spectrum blocked from R1 and from the auxiliary speaker. R1 is an industry-standard 8-Ω L-Pad type variable speaker-volume control. R1 a-b and R1 b-c form a voltage divider network. The audio voltage across R1 b-c is applied to the auxiliary speaker through S2, P2. R1 “a and b” present a constant impedance to C1 and to the amplifier output circuit white offering to the end user the feature of adjusting the audio power delivered to the auxiliary speaker to suit his or her individual psychoacoustic preferences, variations in speaker sensitivities, and efficiencies, variations in listening room acoustical characteristics and other real world variables.

Tapped inductor L1, configured in a step down auto-former mode, satisfies the need for power attenuation while at the same time lightening the load placed on the audio power amplifier. Both of these characteristics are desirable for this application. Unlike typical resistive attenuator networks, L1 itself consumes no audio power and does not place any load on the amplifier output. This enables the high power from the audio amplifier to be attenuated without generating and dissipating heat.

FIG. 18C depicts a high pass filter and a continuously variable series potentiometer attenuator. The potentiometer controls the audio power level delivered to the tweeter.

FIG. 18D depicts a similar circuit except for the addition of a second resistor, R2. R2 limits the maximum audio power delivered to the auxiliary tweeter. R2 also reduces the power requirements for and the cost of R1. FIG. 18D is configured with a high pass filter F and a variable resistive L-pad attenuator R1. This circuit also serves as the basic model for the next three circuits. The high frequency current flows through F and R1 an 8Ω L-pad. The audio voltage across R1, b-c is applied to the auxiliary tweeter through S2, P2. Audio current flowing through R1 a-c and the audio current flowing through the auxiliary tweeter returns to the audio amplifier by the path described above FIG. 18E is configured and functions the same as circuit FIG. 18F except for the addition of R2. R2 limits the maximum audio power delivered to the auxiliary tweeter. R2 also reduces the power requirements for and cost of R1. The high frequency current flows through F, R1 and R2 an 8Ω L-pad. The audio voltage across R1, b-c is applied to the auxiliary tweeter through S2, P2. R1 is selected to reduce the power requirements and cost of R2. Audio current flowing through R1, a-c and the audio current flowing through the auxiliary tweeter returns to the audio amplifier by the path described above. R2 and R3 limit the maximum audio power delivered to the auxiliary tweeter and when necessary help match the amplifier impedance to the auxiliary tweeter impedance. R2 also reduces the power requirements for and cost of R1.

FIG. 18F is configured and functions the same as circuit FIG. 18A except for the addition of R2 and R3. R2 and R3 limit the maximum audio power delivered to the auxiliary tweeter. R3 when necessary helps match the amplifier impedance to the auxiliary tweeter impedance. R2 also reduces the power requirements for and cost of R1. Distributing the power dissipation between R2 and R3 reduces the power requirements for and cost of both.

FIG. 18G is configured and functions the same as FIG. 18E except for the addition of R2. R2 limits the maximum audio power delivered to the auxiliary tweeter and when necessary helps match the amplifier impedance to the auxiliary tweeter impedance. The high frequency current flows through F and R1, an 8Ω L-pad. R2 is a series current limiting resistor to provide some protection for the auxiliary tweeter. The audio voltage across R1, b-c is applied to the auxiliary tweeter through S2, P2. Audio current flowing through R1, a-c and the audio current flowing through the auxiliary tweeter returns to the audio amplifier by the path described above

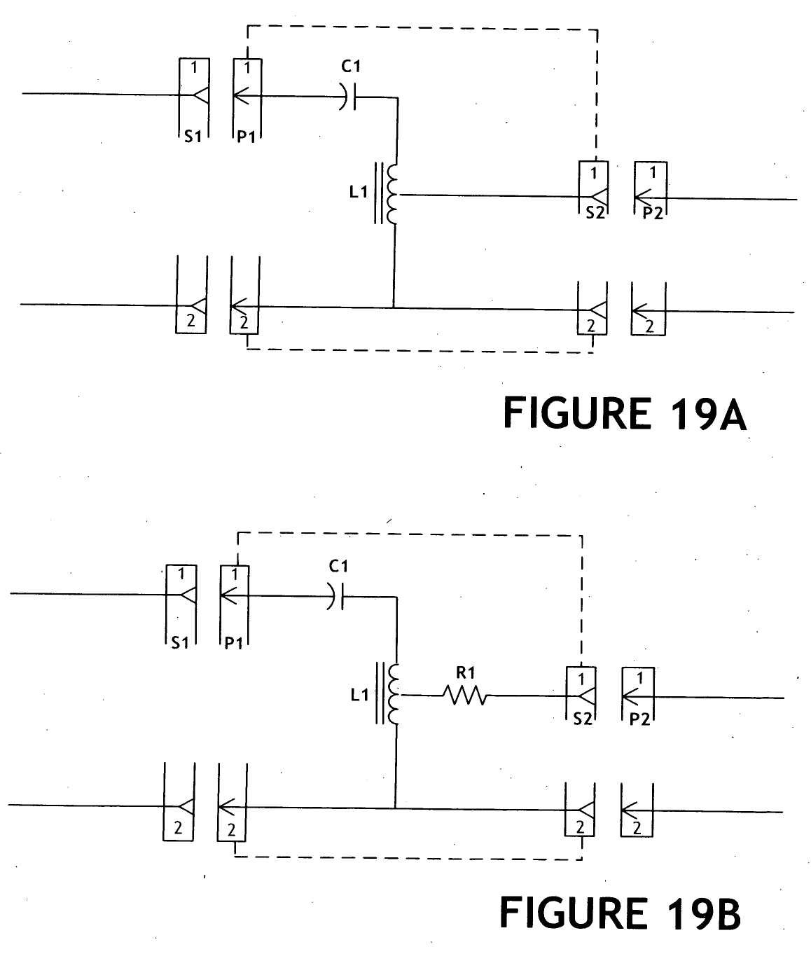

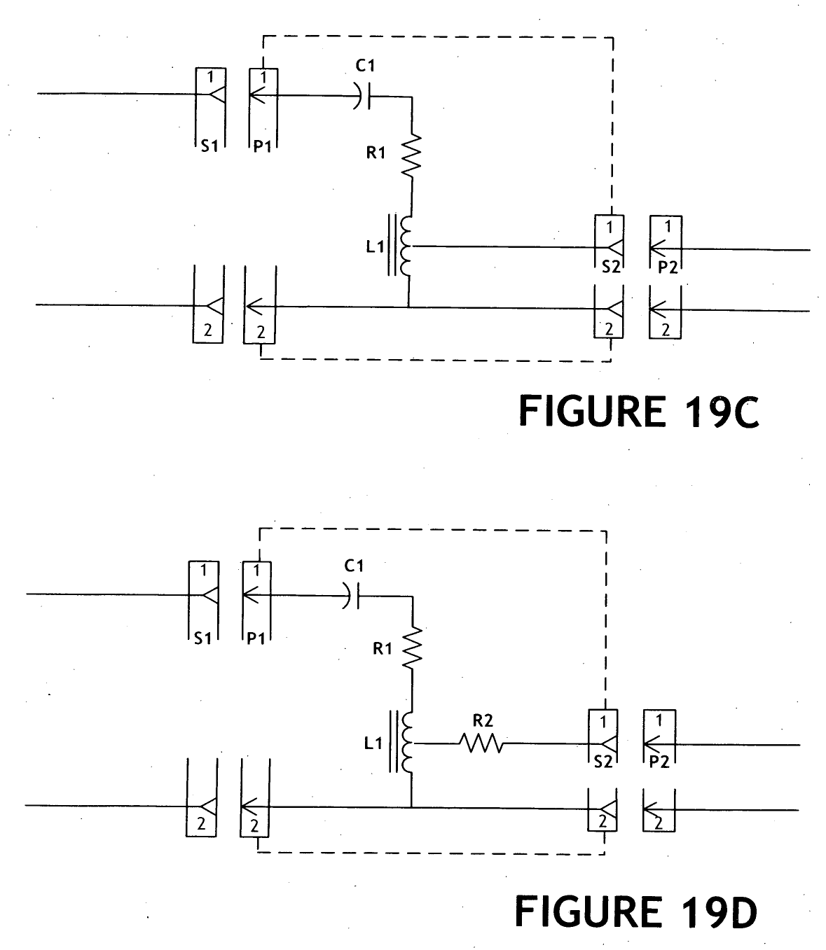

FIG. 19A is the basic factory preset tapped-inductor impedance matching circuit configured with a high-pass filter F and a factory preset impedance matching tapped inductor L1 in a step down auto-former mode. This circuit also serves as the basic model for the next three circuits. Where applicable in the following circuits L1 lead “a” is referred to as the high impedance lead or high side and L1 lead “b” is referred to as the low impedance lead or low side.

The high frequency current flows through F and L1 and returns to the audio amplifier by the path described above. The audio voltage across the L1 winding b-c is applied directly to the auxiliary tweeter through S2 and P2.

The only load seen by the amplifier output is the transformed load of the auxiliary tweeter. With L1 winding b-c loaded by the auxiliary tweeter, the transformed higher impedance of L1 winding a-c presents a smaller load to the amplifier output than would the auxiliary tweeter by itself. An example: if the auxiliary tweeter is 8Ω and if the tap point b on L1 is at the center of windings a-c then L1 would present a 160 load on the amplifier output. The taped winding b-c also matches the impedance of the auxiliary tweeter.

FIG. 19B depicts the same circuit as shown in FIG. 19A except for the addition of R1. R1 limits the maximum audio power delivered to the auxiliary tweeter and when necessary helps match the amplifier impedance to the auxiliary tweeter impedance. R1 also serves to reduce the audio power flowing through L1 thus reducing the power requirements for and cost of L1.

R1 being placed in the low side requires a lower ohmic value than if placed in the high side. The ability to place a resistor in either the high side or low side offers greater flexibility in component purchase availability, component purchase pricing, component terms of purchase, production systems, power ratings of the various components, design goals, and performance goals. This is also advantageous in various product models, various product lines, and various options packages.

FIG. 19C is the same circuit as shown in FIG. 19A except for the addition of R1. R1 limits the maximum audio power delivered to the auxiliary tweeter. R1 also serves to reduce the audio power flowing through L1 thus reducing the power requirements for and cost of L1. R1 being placed in the high side requires a higher ohmic value than if placed in the low side.

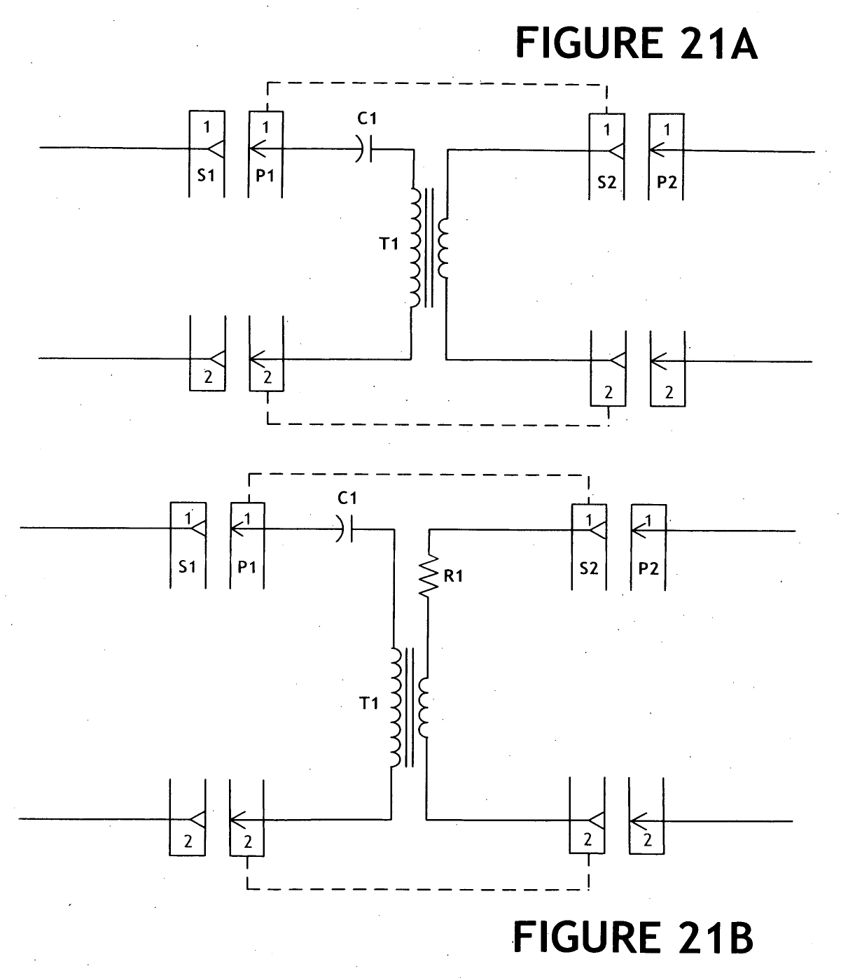

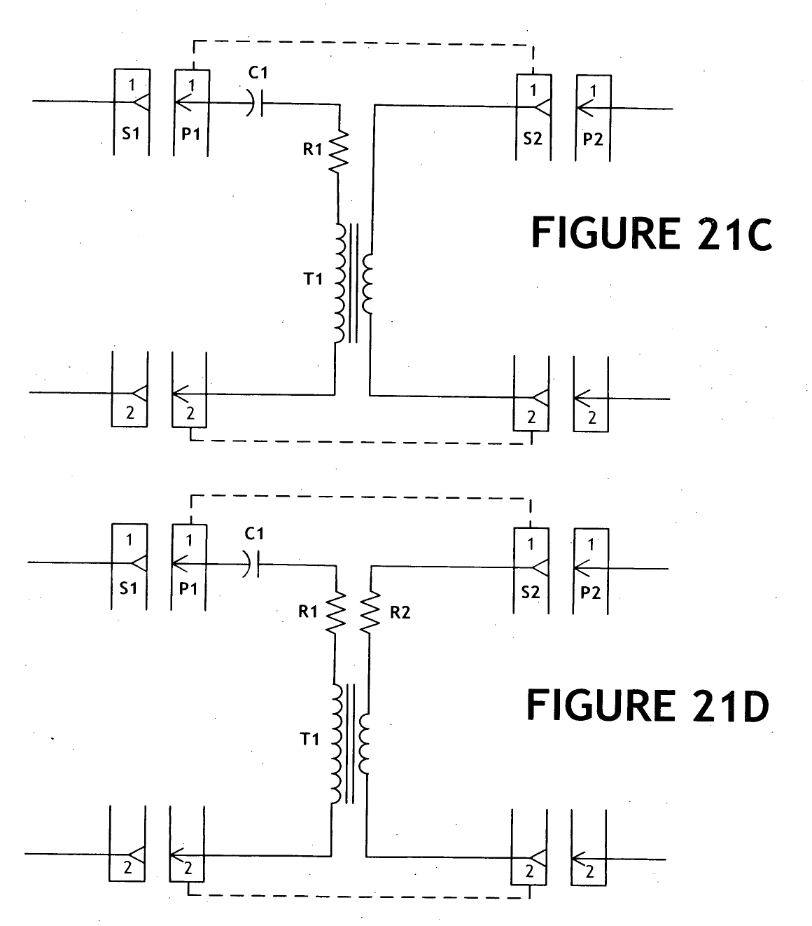

FIG. 19D is the same as FIG. 21A except for the addition of R1 and R2. R1 and R2 serve to reduce the audio power flowing through L1 and thus reducing the power requirements for and cost of L1, R1 and R2 also limit the maximum audio power delivered to the auxiliary tweeter and when necessary help match the amplifier impedance to the auxiliary tweeter impedance. Distributing the power dissipation between R1 and R2 reduces the power requirements for and cost of both. Distributing the power dissipation between R1 and R2 reduces the power requirements for and cost of both.

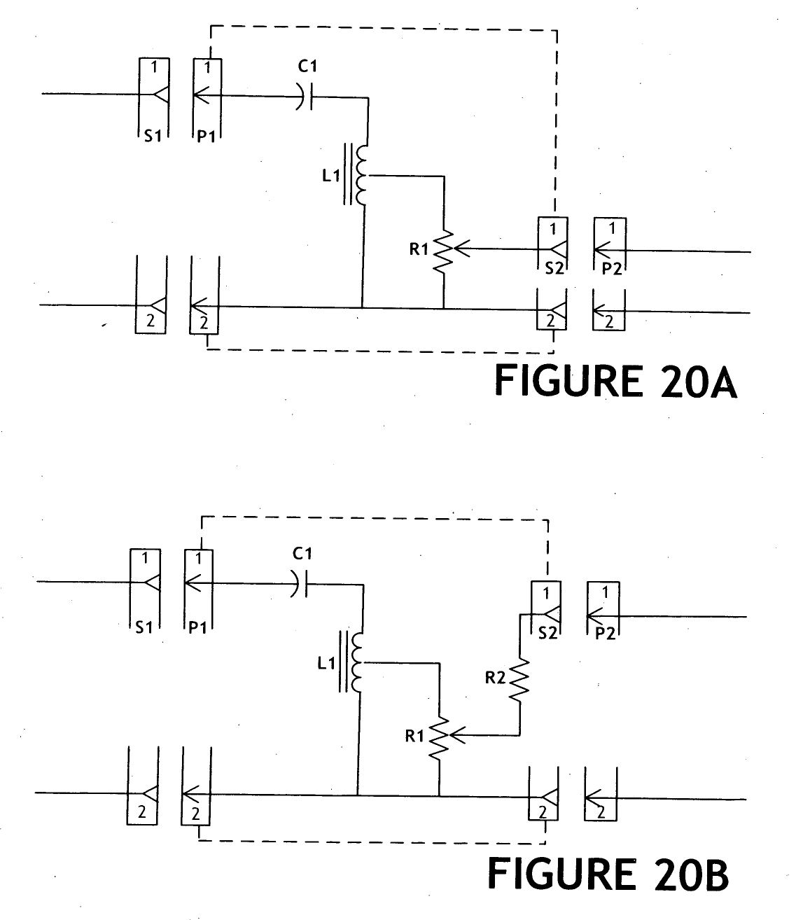

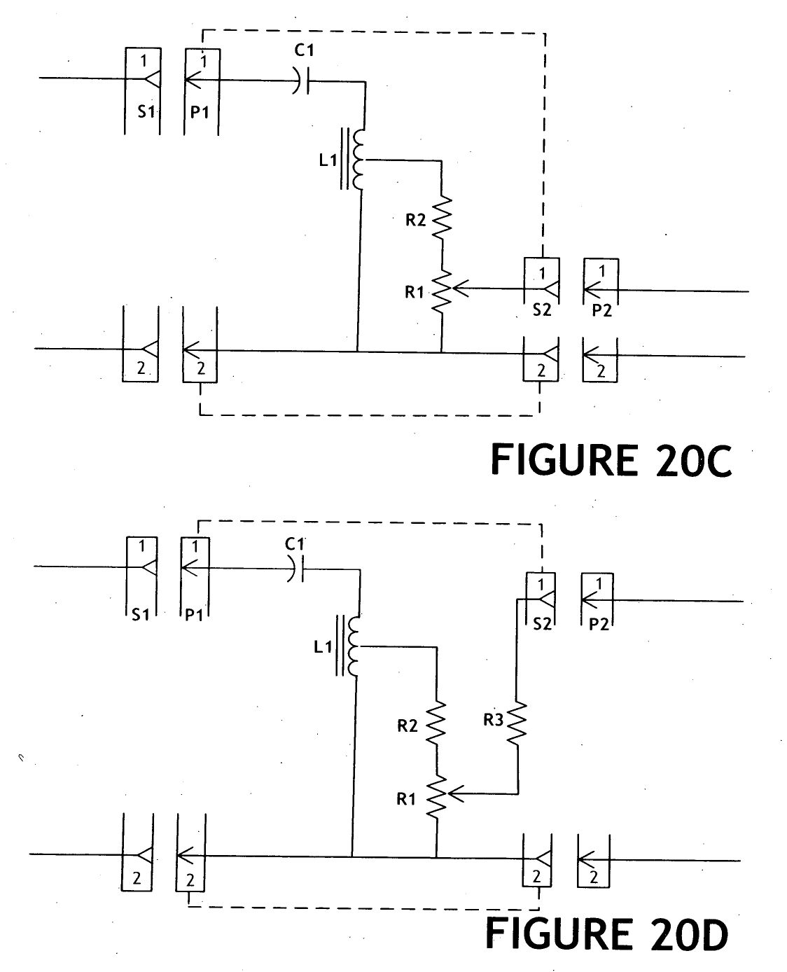

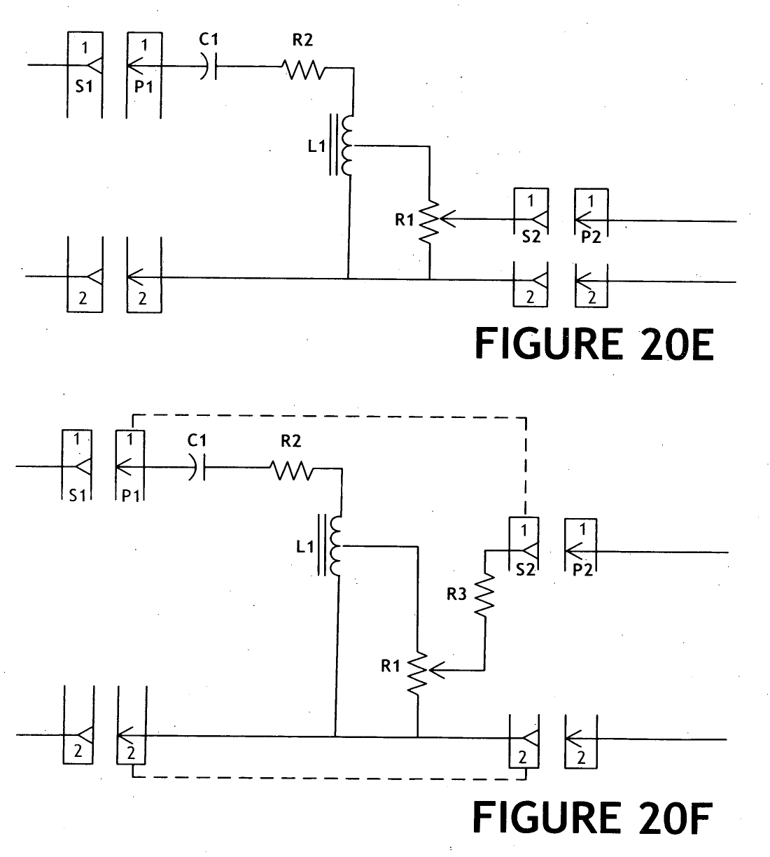

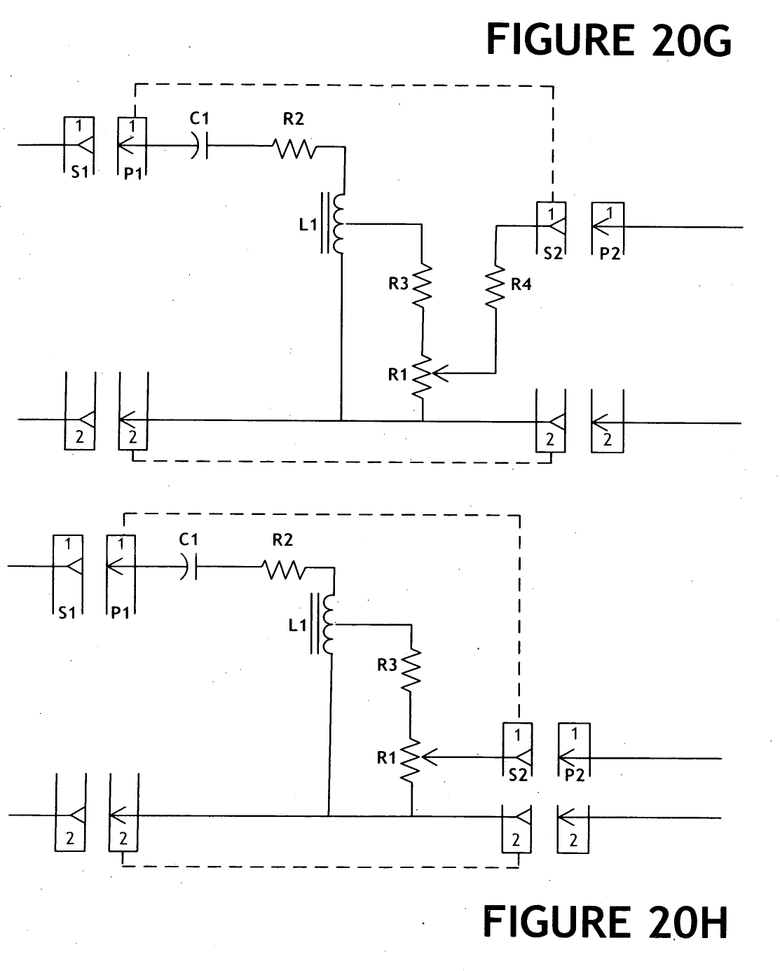

FIG. 20A is the basic configuration for the continuously variable attenuator tapped-inductor impedance matching circuit. It is configured the same and functions the same as the basic factory preset tapped-inductor impedance matching FIG. 21A except for the addition of R1 a variable 8Ω L-pad attenuator. This circuit also serves as the basic model for the next seven circuits. Where applicable in the following circuits R1 lead “d” is referred to as the high impedance lead or high side and R1 lead “e” is referred to as the low impedance lead or low side.

FIG. 20B is the same as the above basic circuit with the addition of R1 and R2. R1 serves to reduce the audio power flowing through L1 thus reducing the power requirements for and cost of L1. R2 serves as a series resistor attenuator and provides some overpower protection for the auxiliary tweeter. R2 and R3 limit the maximum audio power delivered to the auxiliary tweeter and when necessary help match the amplifier impedance to the auxiliary tweeter impedance. R2 also reduces the power requirements for and cost of R1.

In FIG. 20C, R2 and R3 limit the maximum audio power delivered to the auxiliary tweeter and when necessary help match the amplifier impedance to the auxiliary tweeter impedance. R2 also reduces the power requirements for and cost of R1. R1 is placed in the low side of L1 requiring a lower ohmic value than if placed in the high side.

Referring now to FIG. 20D, R2 and R3 limit the maximum audio power delivered to the auxiliary tweeter and when necessary help match the amplifier impedance to the auxiliary tweeter impedance. R2 also reduces the power requirements for and cost of R1. 1 is selected to reduce the power requirements and cost of R2. R1 being placed in the low side requires a lower ohmic value than if placed in the high side. Distributing the power dissipation between R2 and R3 reduces the power requirements for and cost of both.

In FIG. 20E, R2 and R3 limit the maximum audio power delivered to the auxiliary tweeter and when necessary help match the amplifier impedance to the auxiliary tweeter impedance. R2 also reduces the power requirements for and cost of R1. R2 being placed in the high side requires a higher ohmic value than if placed in the low side.

In FIG. 20F, R2 and R3 limit the maximum audio power delivered to the auxiliary tweeter and when necessary help match the amplifier impedance to the auxiliary tweeter impedance. R2 also reduces the power requirements for and cost of R1. R2 being placed in the high side requires a higher ohmic value than if placed in the low side. Distributing the power dissipation between R2 and R3 reduces the power requirements for and cost of both.

In FIG. 20G, R2 and R3 limit the maximum audio power delivered to the auxiliary tweeter and when necessary help match the amplifier impedance to the auxiliary tweeter impedance. R2 also reduces the power requirements for and cost of R1. R2 being placed in the high side requires a higher ohmic value than if placed in the low side. Distributing the power dissipation between R2, R3 and R4 reduces the power requirements for and cost of each.

In FIG. 20H, R2 and R3 limit the maximum audio power delivered to the auxiliary tweeter and when necessary help match the amplifier impedance to the auxiliary tweeter impedance. R2 also reduces the power requirements for and cost of R1. Distributing the power dissipation between R2 and R3 reduces the power requirements for and cost of both. R1 is selected to reduce the power requirements and cost of R2.

FIG. 21A through FIG. 21D depict various continuously variable attenuator tap switched inductor impedance matching circuit series for the stereophonic sound system of the present invention.

Now we turn our attention to factory preset transformer impedance matching circuits. FIG. 21A is configured with a high-pass filter F and a factory preset step down impedance matching transformer T1. The high frequency current flows through F and the primary of T1. T1 is used as a step down transformer and returns to the audio amplifier through pin 2 of P1. The audio voltage across the secondary of T1 is applied through S2, P2 to the auxiliary tweeter. The particular value of F in microfarads, and turn ratio and power rating of T1 is dependant on the design and performance goals of the particular model, options package and product line produced.

T1 satisfies the need for power attenuation while at the same time lightening the load placed on the audio power amplifier. Both these characteristics are desirable in this application. Unlike typical resistive attenuator networks T1 itself consumes no audio power and does not place any load on the amplifier output. The only load seen by the amplifier output is the transformed load of the auxiliary tweeter.

With T1 secondary winding loaded by the auxiliary tweeter, the transformed higher impedance of T1 primary winding presents a smaller load to the amplifier output than would the auxiliary tweeter by itself. An example: if the auxiliary tweeter is 8Ω and if point b on T1 is at the center of windings a-c then T1 would present a 160 load on the amplifier output. The taped winding b-c also matches the impedance of the auxiliary tweeter. The particular value of in microfarads, and inductance and power rating of L1 is dependant on the design and performance goals of the particular model, options package and product line produced.

Referring now to FIG. 21B, R2 and R3 limit the maximum audio power delivered to the auxiliary tweeter and when necessary help match the amplifier impedance to the auxiliary tweeter impedance. R2 also reduces the power requirements for and cost of R1. R1 being placed in the low side requires a lower ohmic value than if placed in the high side. R1 is a series current limiting resistor to provide some protection for the auxiliary tweeter.

Referring now to FIG. 21C, R2 and R3 limit the maximum audio power delivered to the auxiliary tweeter and when necessary help match the amplifier impedance to the auxiliary tweeter impedance. R2 also reduces the power requirements for and cost of R1. R1 being placed in the high side requires a higher ohmic value than if placed in the low side. R1 is selected to reduce the power requirements and cost of T1.

Referring next to FIG. 21D, R2 and R3 limit the maximum audio power delivered to the auxiliary tweeter and when necessary help match the amplifier impedance to the auxiliary tweeter impedance. R2 also reduces the power requirements for and cost of R1. R1 is a series current limiting resistor to provide some protection for the auxiliary tweeter. Distributing the power dissipation between R2 and R3 reduces the power requirements for and cost of both.

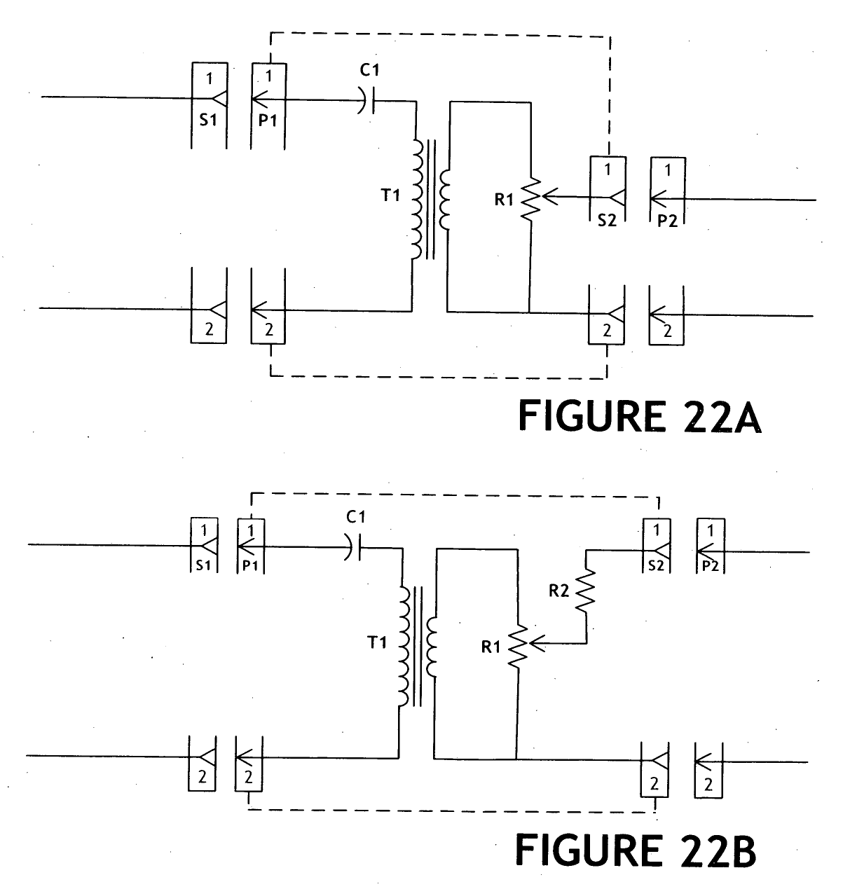

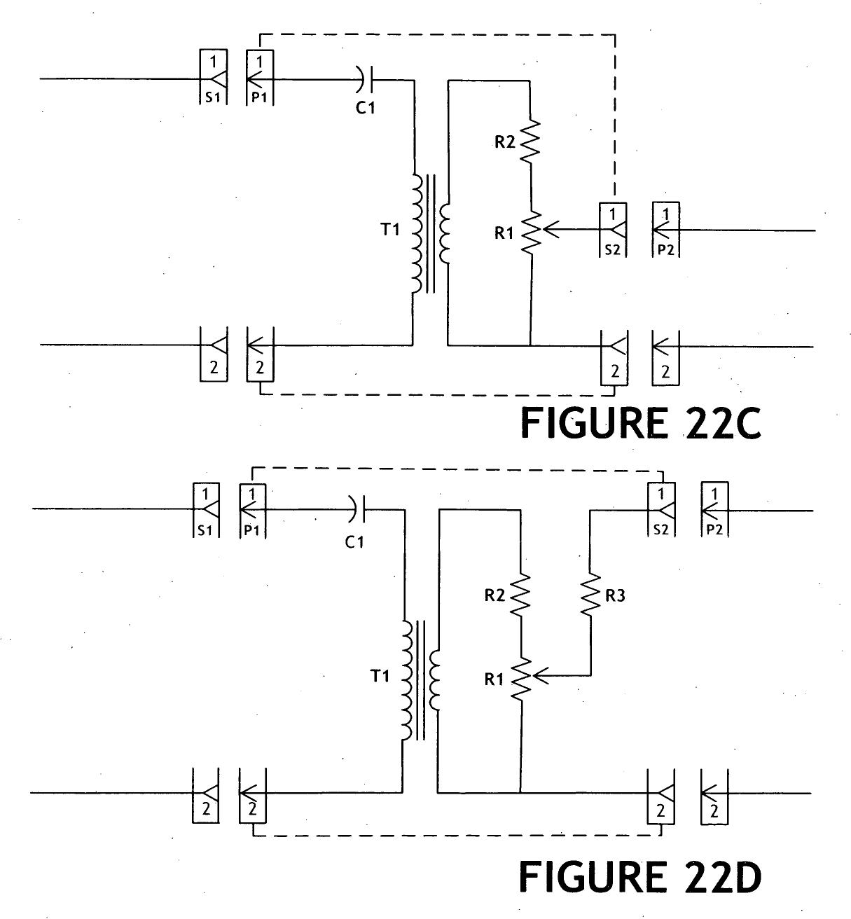

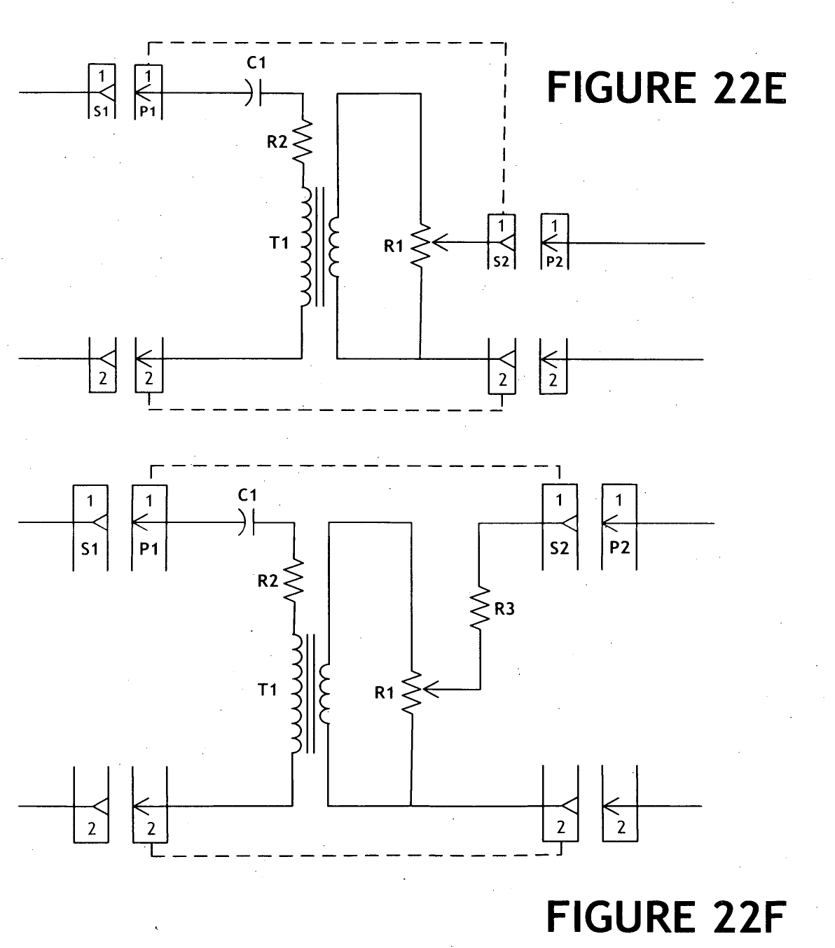

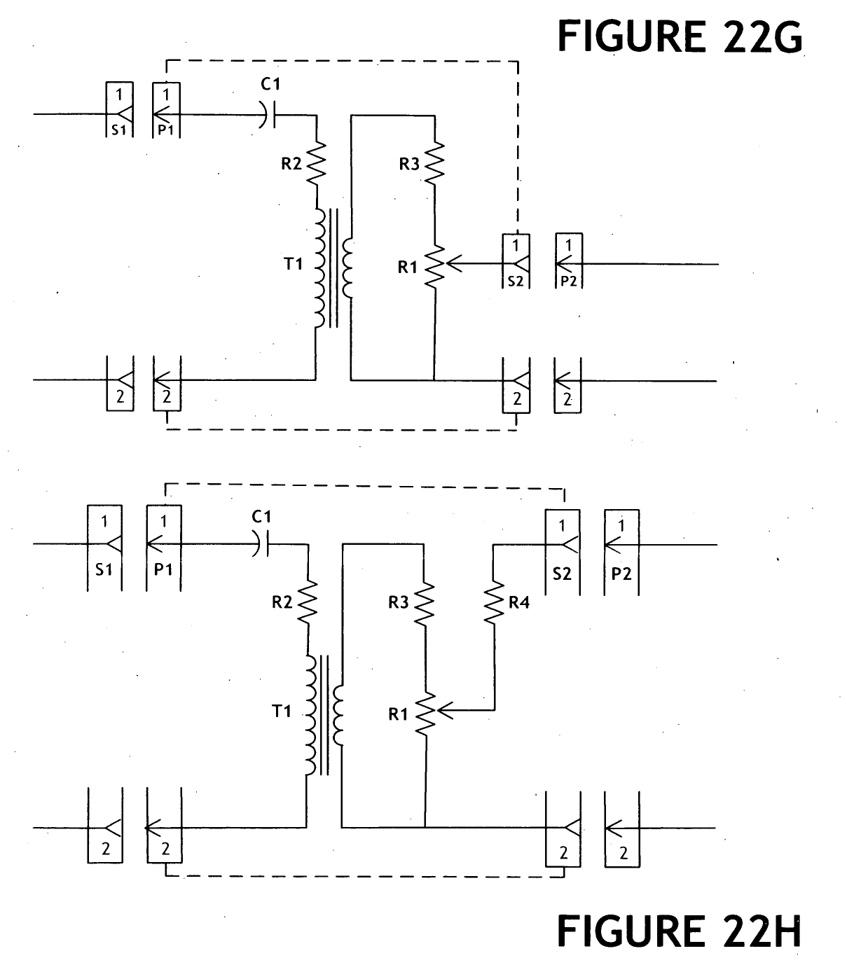

FIG. 22A through FIG. 22H depict various continuously variable attenuator transformer impedance matching circuits for the stereophonic sound system of the present invention.

FIG. 22A is configured with a high-pass filter F, step down impedance matching transformer T1 and variable resistive L-pad attenuator R1. The high frequency current flows through F and the primary of T1. T1 is used as a step down transformer and returns to the audio amplifier through pin 2 of P1. The audio voltage across the secondary of T1 is applied to R1 an 8Ω L-pad. The audio voltage across the lower leg of R1 and the armature of R1 is applied through S2, P2 to the auxiliary tweeter. The particular value of F in microfarads, and turn ratio and power rating of T1, and power rating of R1 is dependant on the design and performance goals of the particular model, options package and product line produced. One of several advantages of this circuit is a lower power and therefore less expensive R1 may be used.

In FIG. 22B, R2 and R3 limit the maximum audio power delivered to the auxiliary tweeter and when necessary help match the amplifier impedance to the auxiliary tweeter impedance. R2 also reduces the power requirements for and cost of R1.

In FIG. 22C, R2 and R3 limit the maximum audio power delivered to the auxiliary tweeter and when necessary help match the amplifier impedance to the auxiliary tweeter impedance. R2 also reduces the power requirements for and cost of R1. R1 being placed in the low side requires a lower ohmic value than if placed in the high side.

In FIG. 22D, R2 and R3 limit the maximum audio power delivered to the auxiliary tweeter and when necessary help-match the amplifier impedance to the auxiliary tweeter impedance. R2 also reduces the power requirements for and cost of R1. R1 being placed in the low side requires a lower ohmic value than if placed in the high side. Distributing the power dissipation between R2 and R3 reduces the power requirements for and cost of both.

Referring now to FIG. 22E, R2 and R3 limit the maximum audio power delivered to the auxiliary tweeter and when necessary help match the amplifier impedance to the auxiliary tweeter impedance. R2 also reduces the power requirements for and cost of R1. R2 being placed in the high side requires a higher ohmic value than if placed in the low side.

In FIG. 22F, R2 and R3 limit the maximum audio power delivered to the auxiliary tweeter and when necessary help match the amplifier impedance to the auxiliary tweeter impedance. R2 also reduces the power requirements for and cost of R1. R2 being placed in the high side requires a higher ohmic value than if placed in the low side. Distributing the power dissipation between R2 and R3 reduces the power requirements for and cost of both.

Next referring to FIG. 22G, R2 and R3 limit the maximum audio power delivered to the auxiliary tweeter and when necessary help match the amplifier impedance to the auxiliary tweeter impedance. R2 also reduces the power requirements for and cost of R1. R2 being placed in the high side requires a higher ohmic value than if placed in the low side. Distributing the power dissipation between R2 and R3 reduces the power requirements for and cost of both.

Referring now to FIG. 22H, R2 and R3 limit the maximum audio power delivered to the auxiliary tweeter and when necessary help match the amplifier impedance to the auxiliary tweeter impedance. R2 also reduces the power requirements for and cost of R1. Distributing the power dissipation between R2, R3 and R4 reduces the power requirements for and cost of each.

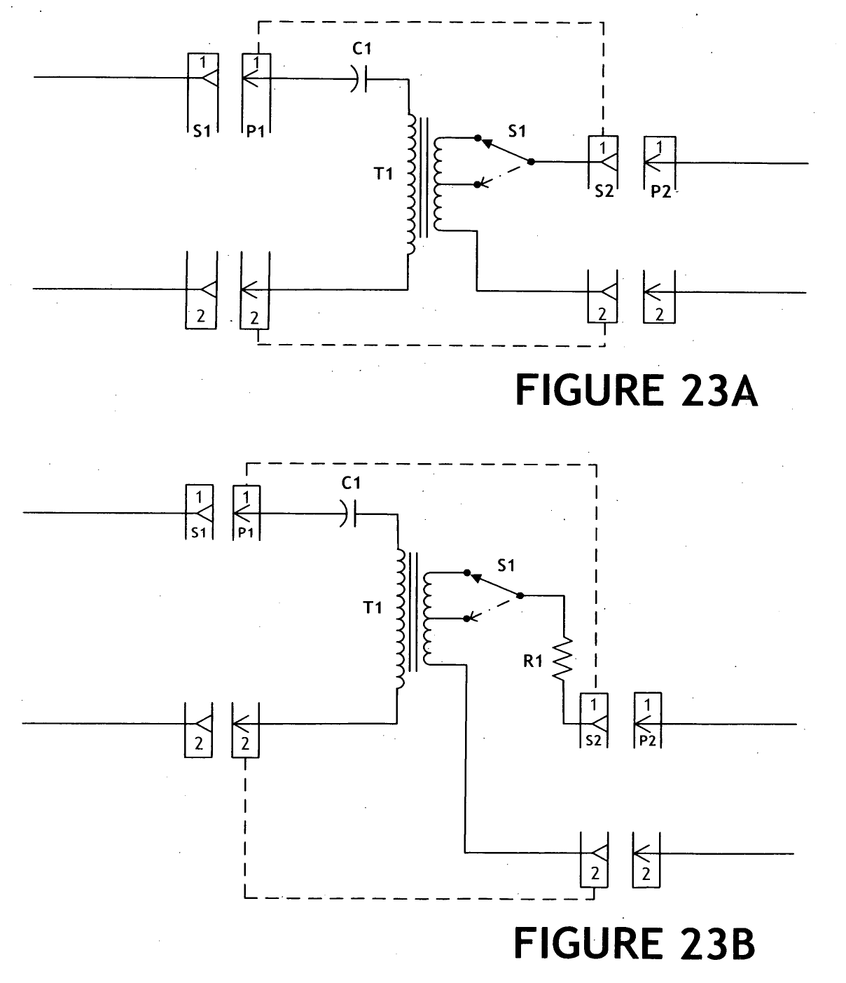

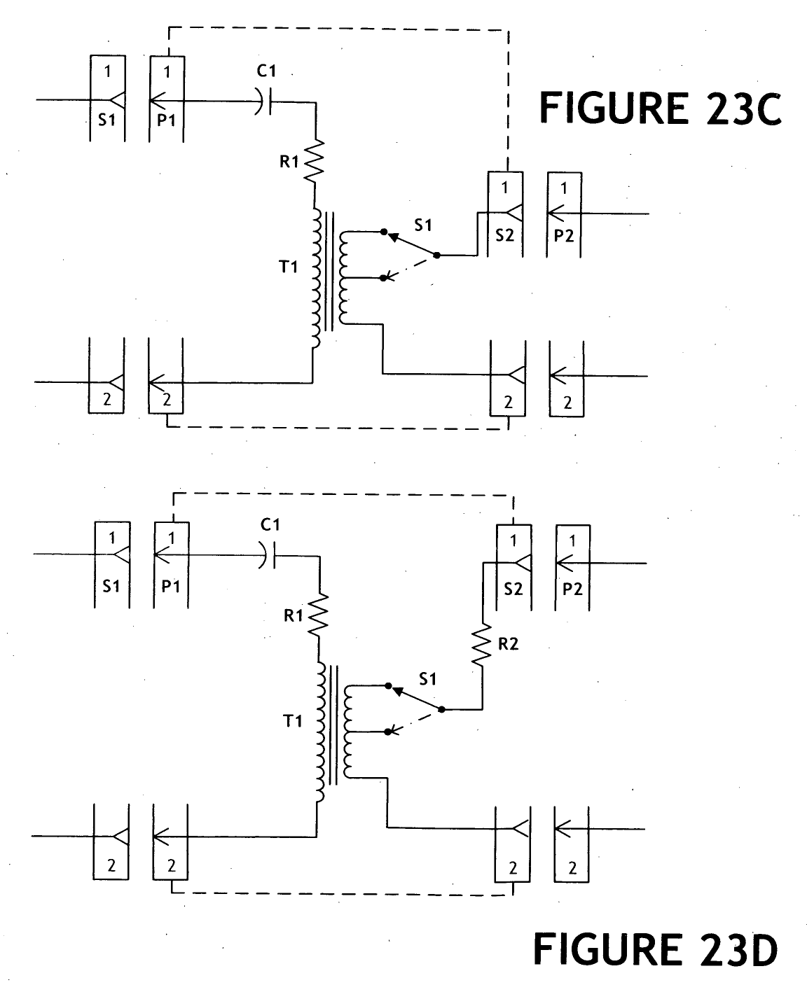

FIG. 23A through FIG. 23D depict various factory preset static attenuator tap switched transformer impedance matching circuits for the stereophonic sound system of the present invention.

FIG. 23A depicts a basic circuit for switching between high and low power taps.

In FIG. 23B, R2 and R3 limit the maximum audio power delivered to the auxiliary tweeter and when necessary help match the amplifier impedance to the auxiliary tweeter impedance. R2 also reduces the power requirements for and cost of R1.

In FIG. 23C, R2 and R3 limit the maximum audio power delivered to the auxiliary tweeter and when necessary help match the amplifier impedance to the auxiliary tweeter impedance. R2 also reduces the power requirements for and cost of R1. R2 being placed in the high side requires a higher ohmic value than if placed in the low side.

In FIG. 23D, R2 and R3 limit the maximum audio power delivered to the auxiliary tweeter and when necessary help match the amplifier impedance to the auxiliary tweeter impedance. R2 also reduces the power requirements for and cost of R1. Distributing the power dissipation between R1 and R2 reduces the power requirements for and cost of both.

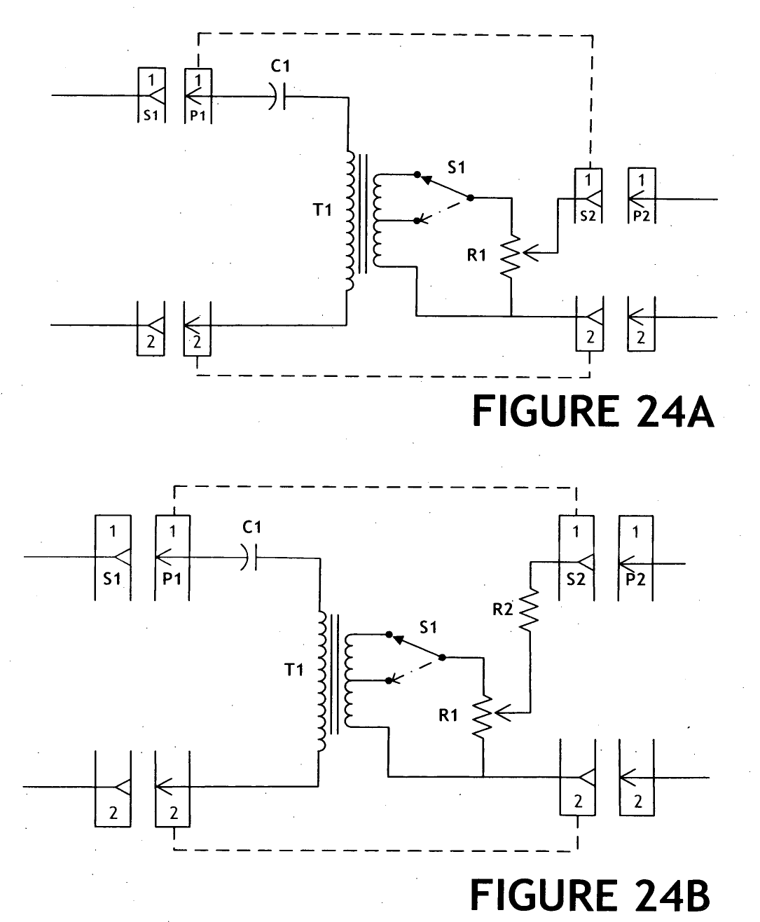

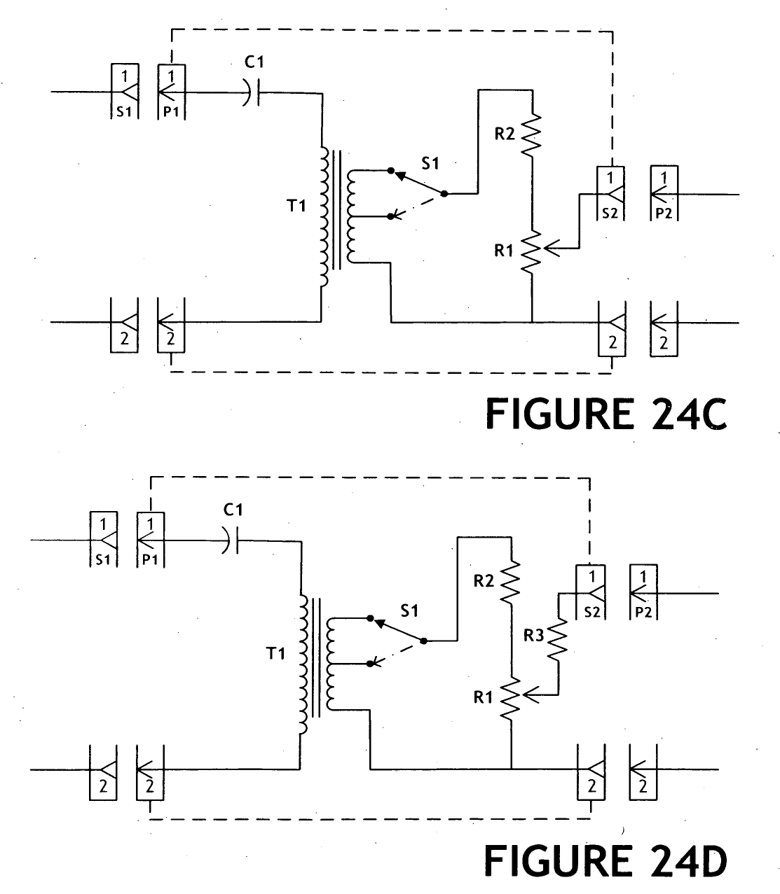

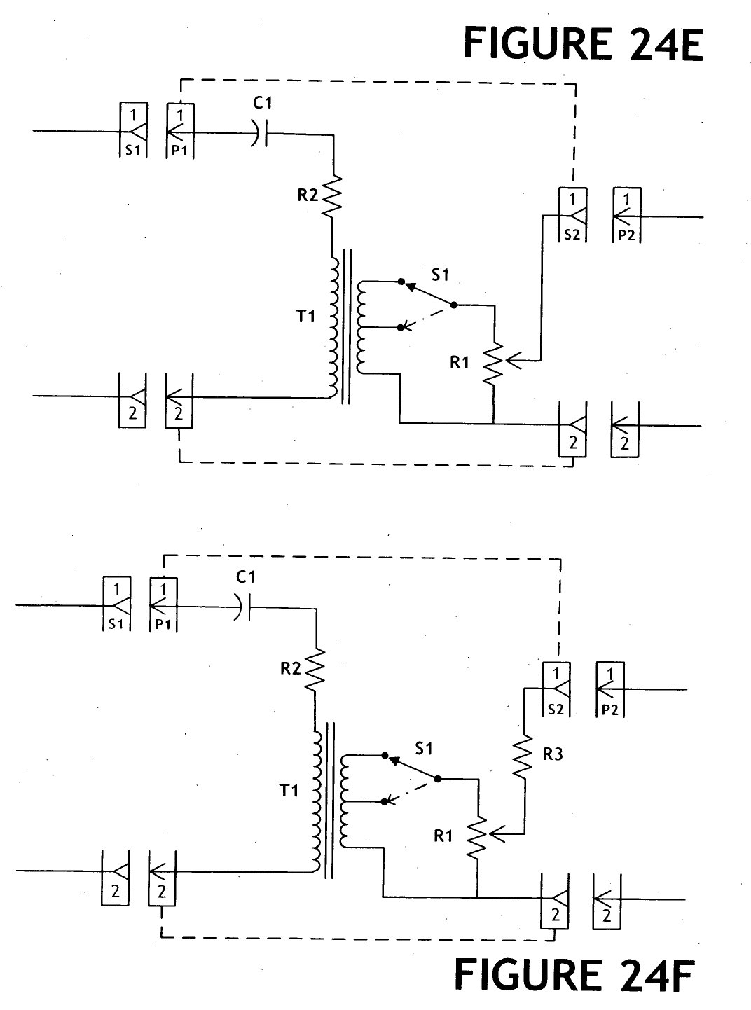

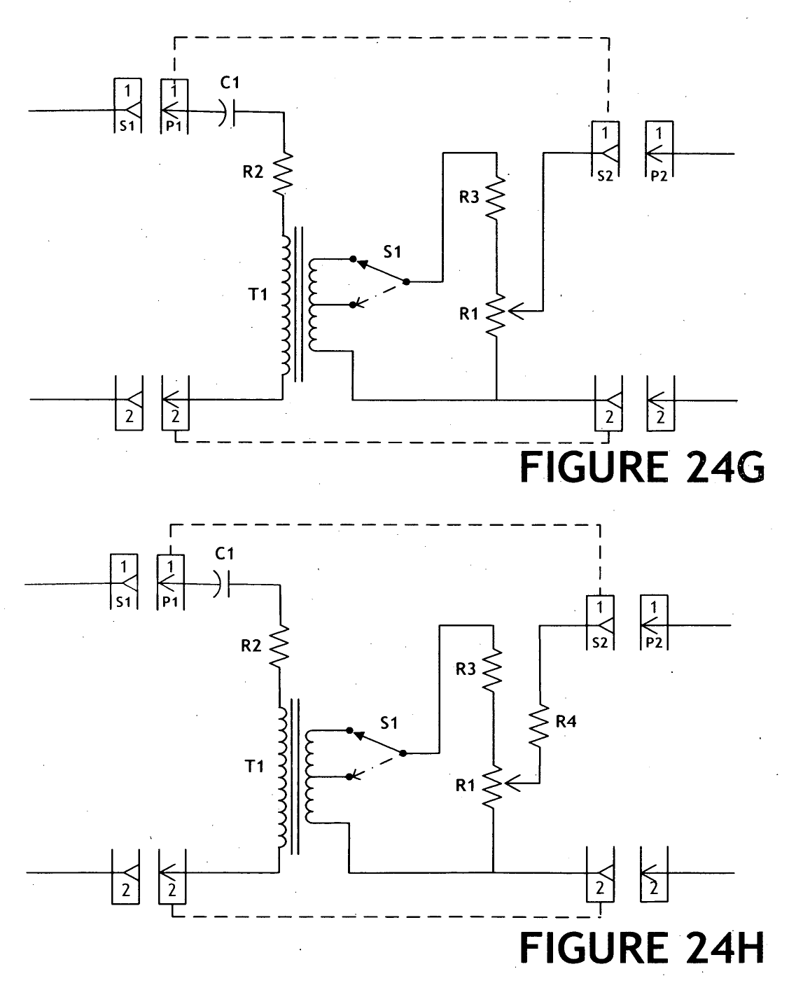

FIG. 24A through FIG. 24E depict various continuously variable attenuator tap switched transformer impedance matching circuit for the stereophonic sound system of the present invention.

FIG. 24A depicts a basic circuit for switching between high and low power taps.

In FIG. 24B, R2 and R3 limit the maximum audio power delivered to the auxiliary tweeter and when necessary help match the amplifier impedance to the auxiliary tweeter impedance. R2 also reduces the power requirements for and cost of R1.

In FIG. 24C, R2 and R3 limit the maximum audio power delivered to the auxiliary tweeter and when necessary help match the amplifier impedance to the auxiliary tweeter impedance. R2 also reduces the power requirements for and cost of R1. R2 being placed in the low side requires a lower ohmic value than if placed in the high side.

In FIG. 24D, R2 and R3 limit the maximum audio power delivered to the auxiliary tweeter and when necessary help match the amplifier impedance to the auxiliary tweeter impedance. R2 also reduces the power requirements for and cost of R1. R2 being placed in the low side requires a lower ohmic value than if placed in the high side. Distributing the power dissipation between R2 and R3 reduces the power requirements for and cost of both.

In FIG. 24E, R2 and R3 limit the maximum audio power delivered to the auxiliary tweeter and when necessary help match the amplifier impedance to the auxiliary tweeter impedance. R2 also reduces the power requirements for and cost of R1. R2 being placed in the high side requires a higher ohmic value than if placed in the low side.

In FIG. 24F, R2 and R3 limit the maximum audio power delivered to the auxiliary tweeter and when necessary help match the amplifier impedance to the auxiliary tweeter impedance. R2 also reduces the power requirements for and cost of R1. R2 being placed in the high side requires a higher ohmic value than if placed in the low side. Distributing the power dissipation between R2 and R3 reduces the power requirements for and cost of both.

In FIG. 24G, R2 and R3 limit the maximum audio power delivered to the auxiliary tweeter and when necessary help match the amplifier impedance to the auxiliary tweeter impedance. R2 also reduces the power requirements for and cost of R1. Distributing the power dissipation between R2 and R3 reduces the power requirements for and cost of both.

Referring now to FIG. 24H, R2 and R3 limit the maximum audio power delivered to the auxiliary tweeter and when necessary help match the amplifier impedance to the auxiliary tweeter impedance. R2 also reduces the power requirements for and cost of R1. Distributing the power dissipation between R2, R3 and R4 reduces the power requirements for and cost of both.

Throughout this application, various patents are referenced by patent number and inventor. The disclosures of these patents and Applications in their entireties are hereby incorporated by reference into this specification in order to more fully describe the state of the art to which this invention pertains.

It is evident that many alternatives, modifications, and variations of the stereophonic sound system of the present invention will be apparent to those skilled in the art in light of the disclosure herein. It is intended that the metes and bounds of the present invention be determined by the appended claims rather than by the language of the above specification, and that all such alternatives, modifications, and variations which form a conjointly cooperative equivalent are intended to be included within the spirit and scope of these claims.

1. A stereo loudspeaker system comprising:
a. a first and a second main speaker, the first main speaker being spaced apart from the second main speaker;
b. a first and a second auxiliary speaker, the first auxiliary speaker being positioned relative to the first main speaker, the second auxiliary speaker being positioned relative to the second main speaker;
c. means for blocking low frequency audio power from being delivered to the auxiliary speakers, the low frequency audio power being from about 100 Hz to about 3,000 Hz;
d. means for using a phase shift circuit to vary the phase relationship between the main speakers and the auxiliary speakers, the phase shift circuit controlling the phase angle relationship between audio power delivered to the main speakers and audio power delivered to the auxiliary speakers; and
e. means for attenuating audio power level delivered to the first and the second auxiliary speakers, first auxiliary audio power level delivered to the first auxiliary speaker being attenuated relative to the first main audio power level delivered to the first main speaker so that radiated sound pressure level from the first auxiliary speakers is equal to or less than the radiated sound pressure level from the first main speaker, second auxiliary audio power level delivered to the second auxiliary speaker being attenuated relative to the second main audio power level delivered to the second main speaker so that radiated sound pressure level from the second auxiliary speakers is equal to or less than the radiated sound pressure level from the second main speaker;
wherein acoustic power emanating from the first main speaker and the first auxiliary speaker blend together to form a wider dispersion angle than the acoustic power emanating from the first main speaker; and
wherein acoustic power emanating from the second main speaker and the second auxiliary speaker blend together to form a wider dispersion angle than the acoustic power emanating from the second main speaker.

2. A stereo loudspeaker system comprising:
a. a first and a second main speaker, the first main speaker being spaced apart from the second main speaker;
b. a first and a second auxiliary speaker, the first auxiliary speaker being positioned relative to the first main speaker, the second auxiliary speaker being positioned relative to the second main speaker;
c. means for blocking low frequency audio power from being delivered to the auxiliary speakers, the low frequency audio power being from about 100 Hz to about 3,000 Hz;
wherein acoustic power emanating from the first main speaker and the first auxiliary speaker blend together to form a wider dispersion angle than the acoustic power emanating from the first main speaker; and
wherein acoustic power emanating from the second main speaker and the second auxiliary speaker blend together to form a wider dispersion angle than the acoustic power emanating from the second main speaker.

3. The stereophonic loudspeaker system of claim 2, whereby the blocking of the tow frequency audio power from being delivered to the auxiliary speakers prevents low frequency phase distortion between the auxiliary speakers and the main speakers.

4. The stereophonic loudspeaker system of claim 2, whereby the blocking of the low frequencies reduces the power requirements for remaining stages and for the auxiliary speaker.

5. The stereophonic loudspeaker system of claim 2, further comprising means for using phase shift circuits to vary the phase relationship between the main speakers and the auxiliary speakers, the phase shift circuits controlling the phase angle relationship between audio power delivered to the main speakers and audio power delivered to the auxiliary speakers.

6. The stereophonic loudspeaker system of claim 5, whereby the blocking of the tow frequency audio power from being delivered to the auxiliary speakers prevents phase distortion between the auxiliary speakers and the main speakers.

7. The stereophonic loudspeaker system of claim 2, whereby the right auxiliary speaker is mounted together with the right main speaker and the left auxiliary speaker is mounted together with the left main speaker.

8. The stereophonic loudspeaker system of claim 2, whereby the left main, left auxiliary, right main, and right auxiliary speakers are mounted into a single integrated speaker.

9. A stereo loudspeaker system comprising:
a. a first and a second main speaker, the first main speaker being spaced apart from the second main speaker;
b. a first and a second auxiliary speaker, the first auxiliary speaker being positioned relative to the first main speaker, the second auxiliary speaker being positioned relative to the second main speaker;
c. means for using a phase shift circuit to vary the phase relationship between the main speakers and the auxiliary speakers, the phase shift circuit controlling the phase angle relationship between audio power delivered to the main speakers and audio power delivered to the auxiliary speakers;
wherein acoustic power emanating from the first main speaker and the first auxiliary speaker blend together to form a wider dispersion angle than the acoustic power emanating from the first main speaker; and
wherein acoustic power emanating from the second main speaker and the second auxiliary speaker blend together to form a wider dispersion angle than the acoustic power emanating from the second main speaker.

10. The stereophonic loudspeaker system of claim 9, whereby the phase shift circuit alters the electrical phase of the audio power delivered to the auxiliary speaker with respect to the main speaker.

11. The stereophonic loudspeaker system of claim 9, whereby the right auxiliary speaker is mounted together with the right main speaker and the left auxiliary speaker is mounted together with the left main speaker.

12. The stereophonic loudspeaker system of claim 9, whereby the left main, left auxiliary, right main, and right auxiliary speakers are mounted into a single integrated speaker.

13. The stereophonic loudspeaker system of claim 9, further comprising means for attenuating audio power level delivered to the first and the second auxiliary speakers, first auxiliary audio power level delivered to the first auxiliary speaker being attenuated relative to the first main audio power level delivered to the first main speaker so that radiated sound pressure level from the first auxiliary speakers is equal to or less than the radiated sound pressure level from the first main speaker, second auxiliary audio power level delivered to the second auxiliary speaker being attenuated relative to the second main audio power level delivered to the second main speaker so that radiated sound pressure level from the second auxiliary speakers is equal to or less than the radiated sound pressure level from the second main speaker;

14. A stereo loudspeaker system comprising:
a. a first and a second main speaker, the first main speaker being spaced apart from the second main speaker;
b. a first and a second auxiliary speaker, the first auxiliary speaker being positioned relative to the first main speaker, the second auxiliary speaker being positioned relative to the second main speaker;
c. means for attenuating audio power level delivered to the first and the second auxiliary speakers, first auxiliary audio power level delivered to the first auxiliary speaker being attenuated relative to the first main audio power level delivered to the first main speaker so that radiated sound pressure level from the first auxiliary speakers is equal to or less than the radiated sound pressure level from the first main speaker, second auxiliary audio power level delivered to the second auxiliary speaker being attenuated relative to the second main audio power level delivered to the second main speaker so that radiated sound pressure level from the second auxiliary speakers is equal to or less than the radiated sound pressure level from the second main speaker;
wherein acoustic power emanating from the first main speaker and the first auxiliary speaker blend together to form a wider dispersion angle than the acoustic power emanating from the first main speaker; and
wherein acoustic power emanating from the second main speaker and the second auxiliary speaker blend together to form a wider dispersion angle than the acoustic power emanating from the second main speaker.

14. The stereophonic loudspeaker system of claim 13, whereby the first and second audio power level delivered to the first and second auxiliary speakers is less than the first and second audio power lower delivered to the first and second main speakers.

15. The stereophonic loudspeaker system of claim 13, whereby the attenuation power level of the first and second auxiliary speakers relative to the first and second main speakers is at a lower power end of a setting range of a just noticeable difference power level.

16. The stereophonic loudspeaker system of claim 13, whereby the right auxiliary speaker is mounted together with the right main speaker and the left auxiliary speaker is mounted together with the left main speaker.

17. The stereophonic loudspeaker system of claim 13, whereby the left main, left auxiliary, right main, and right auxiliary speakers are mounted into a single integrated speaker.

18. The stereophonic loudspeaker system of claim 13, further comprising means for blocking tow frequency audio power from being delivered to the auxiliary speakers, the low frequency audio power being from about 100 Hz to about 3,000 Hz.
